(19) United States
(12) Patent Application Publication
(10) Pub. No.: US 2008/0109315 A1
(43) Pub. Date: May 8, 2008

(54) METHOD AND APPARATUS FOR DETERMINING A CUSTOMER'S LIKELIHOOD OF PAYING OFF A FINANCIAL ACCOUNT

(76) Inventors: Xiao-Ming Huang, West Park (GB); Saumitra N. Bhaduri, Bangalore (IN); Pritam K. Paul, Bangalore (IN)

Correspondence Address: BUCKLEY, MASCHOFF & TALWALKAR LLC, 50 LOCUST AVENUE, NEW CANAAN, CT, 06840, US

(21) Appl. No.: 11/962,775

(22) Filed: Dec. 21, 2007

Related U.S. Application Data
(62) Division of application No. 10/035,852, filed on Dec. 31, 2001.

(51) Int. Cl. G06Q 30/00

(52) U.S. Cl. 705/14; 705/36 R

(57) ABSTRACT

A system, method, apparatus, means, and computer program code for predicting or otherwise determining a customer's likelihood of paying off a financial account. The financial account may have a maximum loan amount, interest rate, minimum monthly payment, or other term or condition associated with it. In some embodiments, the financial account may be secured or unsecured. The customer's likelihood of paying off the financial account may be predicted or otherwise determined by analyzing various parameters associated with the customer and/or the account. A score may be computed based on the parameters, which is indicative of the customer's likelihood of paying off the financial account. Once the score is computed, it may be used to select or otherwise determine one or more courses of actions (e.g., marketing activities) to take regarding the customer and/or the account.

### CROSS-REFERENCE TO RELATED INVENTION

This patent application is related to co-pending U.S. patent application entitled Method and Apparatus for Determining a Customer's Likelihood of Reusing a Financial Account, patent application Ser. No. ______ (Attorney Docket Number 006-004), filed simultaneously herewith, the contents of which are incorporated herein by reference.

### FIELD OF THE INVENTION

The present invention relates to a method and apparatus for predicting or otherwise determining a customer's likelihood of paying off a financial account and, more particularly, embodiments of the present invention relate to methods, means, apparatus, and computer program code for determining a course of action regarding the customer based on the customer's likelihood of paying off the financial account.

### BACKGROUND OF THE INVENTION

In many countries, particularly those where credit cards or other bank cards are not widely used (e.g., Japan), a financial account may be established that allows a customer to obtain cash from a bank, kiosk, or other entity or device. For example, a revolving loan account may be established between an entity and a customer that allows the customer to borrow money as needed. The loan account may have a maximum loan amount, interest rate, minimum monthly payment, etc. associated with it and may be secured or unsecured. A customer borrowing money via the account then makes payments on the loan as agreed to by the customer and the entity making the loan. The customer benefits from having access to monetary amounts and the entity making the loan earns interest on the monetary amounts borrowed by the customer.

In situations where an entity (e.g., a bank or other lender) has established many accounts, the entity may want to have each account active. That is, the entity may want as many customers as possible to have non-zero balances in the accounts since the entity makes interest for each non-zero account. If a customer will be paying off a financial account, or is otherwise expected to pay off a financial account, the entity may want to enhance its marketing efforts directed to the customer to increase the likelihood that the customer will be retained by borrowing money via the account. Alternatively, the entity may want to target the customer for marketing efforts for different financial products (e.g., credit card, bank card, other financial account). As another option, the entity may want to prevent multiple, duplicate, or conflicting marketing efforts from being directed to the customer. In order to decide a course of action regarding the customer (e.g., marketing activity targeted to the customer), the entity may want to know the likelihood that the customer will soon have a zero balance in a financial account or the likelihood that a customer having a zero-balance in the loan account will reactivate the loan account.

It would be advantageous to provide a method and apparatus that assisted in predicting or otherwise determining a customer's likelihood of paying off a financial account and determining a course of action regarding the customer based on the customer's likelihood of paying off the financial account.

### SUMMARY OF THE INVENTION

Embodiments of the present invention provide a system, method, apparatus, means, and computer program code for predicting or otherwise determining a customer's likelihood of paying off a financial account. In addition, embodiments of the present invention provide a system, method, apparatus, means and computer program code for determining a course of action regarding the customer based on the customer's likelihood of paying off the financial account.

The financial account may have a maximum loan amount, interest rate, minimum monthly payment, or other term or condition associated with it. In some embodiments, the financial account may be secured or unsecured. The customer's likelihood of paying off the financial account may be predicted or otherwise determined by analyzing various parameters associated with the customer and/or the account. A score may be computed based on the parameters, which is indicative of the customer's likelihood of paying off the account. Once the score is computed, it may be used to select or otherwise determine one or more courses of actions (e.g., marketing activities) to take regarding the customer and/or the account.

Additional objects, advantages, and novel features of the invention shall be set forth in part in the description that follows, and in part will become apparent to those skilled in the art upon examination of the following or may be learned by the practice of the invention.

According to embodiments of the present invention, a method for selecting a course of action regarding a customer having a financial account may include determining first data associated with a customer having a financial account; determining second data, the second data regarding the financial account; determining a score associated with the customer based, at least in part, on the first data and the second data, wherein the score is indicative of the customer's likelihood of paying off the financial account; and selecting a course of action regarding the customer based, at least in part, on the score. In another embodiment, a method for determining if a customer is likely to payoff a loan account may include determining data indicative of at least one parameter associated with a loan account; determining data indicative of at least one parameter associated with a customer, wherein the customer is associated with the loan account; determining a first weighted score based on the at least one parameter associated with the loan account; determining a second weighted score based on at least one parameter associated with the customer; determining a final score based on the first weighted score and the second weighted score; and comparing the final score with a threshold indicative of a likelihood that the customer will payoff the loan account. In a further embodiment, a method for determining if a customer is likely to payoff a financial account may include determining a plurality of parameters associated with a financial account and a customer associated with the loan account; determining a weighted score for each of a subset of the plurality of parameters; determining a final score based, at least in part, on the weighted scores, wherein the final score is indicative of the customer's likelihood of paying off the financial account; and determining a course of action regarding the customer based, at least in part, on the final score. In a still further embodiment, a method for selecting a course of action regarding a customer having a financial account may include determining first data associated with a customer having a financial account; determining second data, the second data regarding the financial account; determining a score associated with the customer based, at least in part, on the first data and the second data, wherein the score is indicative of the customer's rate of paying off the financial account; and selecting a course of action regarding the customer based, at least in part, on the score. In an even further embodiment, a method for determining when a customer is likely to payoff a loan account may include determining data indicative of at least one parameter associated with a loan account; determining data indicative of at least one parameter associated with a customer, wherein the customer is associated with the loan account; determining a first weighted score based on the at least one parameter associated with the loan account; determining a second weighted score based on at least one parameter associated with the customer; determining a final score based on the first weighted score and the second weighted score; and comparing the final score with a threshold indicative of when the customer is likely to payoff the loan account. In another embodiment, a method for selecting a course of action regarding a customer having a financial account may include determining a first score associated with a customer based, wherein the first score is indicative of the customer's likelihood of paying off a financial account; determining a second score associated with the customer, wherein the second score is indicative of the customer's rate of paying off the financial account; and selecting a course of action regarding the customer based, at least in part, on the first score and the second score.

According to embodiments of the present invention, a system for determining a course of action regarding a customer having a financial account may include memory; communication port; and a processor connected to the memory and the communication port, the processor being operative to determine first data associated with a customer having a financial account; determine second data, the second data regarding the financial account; determine a score associated with the customer based, at least in part, on the first data and the second data, wherein the score is indicative of the customer's likelihood of paying off the financial account; and select a course of action regarding the customer based, at least in part, on the score. In another embodiment, a system for determining if a customer is likely to payoff a loan account may include memory; communication port; and a processor connected to the memory and the communication port, the processor being operative to determine data indicative of at least one parameter associated with a loan account; determine data indicative of at least one parameter associated with a customer, wherein the customer is associated with the loan account; determining a first weighted score based on the least one parameter associated with the loan account; determine a second weighted score based on at least one parameter associated with the customer; determining a final score based on the first weighted score and the second weighted score; and compare the final score with a threshold indicative of a likelihood that the customer will payoff the loan account. In a further embodiment, a system for determining if a customer is likely to payoff a financial account may include memory; communication port; and a processor connected to the memory and the communication port, the processor being operative to determine a plurality of parameters associated with a financial account and a customer associated with the loan account; determine a weighted score for each of a subset of the plurality of parameters; determine a final score based, at least in part, on the weighted scores, wherein the final score is indicative of the customer's likelihood of paying off the financial account; and determine a course of action regarding the customer based, at least in part, on the final score. In a still further embodiment, a system for determining a course of action regarding a customer having a financial account may include memory; communication port; and a processor connected to the memory and the communication port, the processor being operative to determine first data associated with a customer having a financial account; determine second data, the second data regarding the financial account; determine a score associated with the customer based, at least in part, on the first data and the second data, wherein the score is indicative of the customer's rate of paying off the financial account in a given time period; and select a course of action regarding the customer based, at least in part, on the score. In an even further embodiment, a system for determining a course of action regarding a customer having a financial account may include memory; communication port; and a processor connected to the memory and the communication port, the processor being operative to determine data indicative of at least one parameter associated with a loan account; determine data indicative of at least one parameter associated with a customer, wherein the customer is associated with the loan account; determine a first weighted score based on the least one parameter associated with the loan account; determine a second weighted score based on at least one parameter associated with the customer; determine a final score based on the first weighted score and the second weighted score; and compare the final score with a threshold indicative of the customer paying off the loan account in a given time period. In another embodiment, a system for selecting a course of action regarding a customer having a financial account may include a memory, communication port, and a processor connected to the memory and the communication port, the processor being operative to determine a first score associated with a customer based, wherein the first score is indicative of the customer's likelihood of paying off a financial account; determine a second score associated with the customer, wherein the second score is indicative of the customer's rate of paying off the financial account; and select a course of action regarding the customer based, at least in part, on the first score and the second score.

According to embodiments of the present invention, a computer program product in a computer readable medium for selecting a course of action regarding a customer having a financial account may include first instructions for obtaining first data associated with a customer having a financial account; second instructions for obtaining second data, the second data regarding the financial account; third instructions for associating a score with the customer based, at least in part, on the first data and the second data, wherein the score is indicative of the customer's likelihood of paying off the financial account; and fourth instructions for determining a course of action regarding the customer based, at least in part, on the score. In another embodiment, a computer program product in a computer readable medium for selecting a course of action regarding a customer having a financial account may include first instructions for obtaining data indicative of at least one parameter associated with a loan account; second instructions for obtaining data indicative of at least one parameter associated with a customer, wherein the customer is associated with the loan account; third instructions for generating a first weighted score based on the least one parameter associated with the loan account; fourth instructions for generating a second weighted score based on at least one parameter associated with the customer; fifth instructions for generating a final score based on the first weighted score and the second weighted score; and sixth instructions for making a comparison between the final score and a threshold indicative of a likelihood that the customer will payoff the loan account. In a further embodiment, a computer program product in a computer readable medium for selecting a course of action regarding a customer having a financial account may include first instructions for generating a plurality of parameters associated with a financial account and a customer associated with the loan account; second instructions for generating a weighted score for each of a subset of the plurality of parameters; third instructions for generating a final score based, at least in part, on the weighted scores, wherein the final score is indicative of the customer's likelihood of paying off the financial account; and fourth instructions for identifying a course of action regarding the customer based, at least in part, on the final score. In a still further embodiment, a computer program product in a computer readable medium for selecting a course of action regarding a customer having a financial account may include first instructions for obtaining first data associated with a customer having a financial account; second instructions for obtain second data, the second data regarding the financial account; third instructions for generating a score associated with the customer based, at least in part, on the first data and the second data, wherein the score is indicative of the customer's rate of paying off the financial account in a given time period; and fourth instructions for determining a course of action regarding the customer based, at least in part, on the score. In an even further embodiment, a computer program product in a computer readable medium for selecting a course of action regarding a customer having a financial account may include first instructions for obtaining data indicative of at least one parameter associated with a loan account; second instructions for obtaining data indicative of at least one parameter associated with a customer, wherein the customer is associated with the loan account; third instructions for generating a first weighted score based on the least one parameter associated with the loan account; fourth instructions for generating a second weighted score based on at least one parameter associated with the customer; fifth instructions for generating a final score based on the first weighted score and the second weighted score; and sixth instructions for making a comparison between the final score and a threshold indicative of the customer paying off the loan account in a given time period. In another embodiment, a computer program in a computer readable medium for selecting a course of action regarding a customer having a financial account may include first instructions for identifying a first score associated with a customer based, wherein the first score is indicative of the customer's likelihood of paying off a financial account; second instructions for identifying a second score associated with the customer, wherein the second score is indicative of the customer's rate of paying off the financial account; and third instructions for identifying a course of action regarding the customer based, at least in part, on the first score and the second score.

According to embodiments of the present invention, an apparatus for selecting a course of action regarding a customer having a financial account may include means for obtaining first data associated with a customer having a financial account; means for obtaining second data, the second data regarding the financial account; means for associating a score with the customer based, at least in part, on the first data and the second data, wherein the score is indicative of the customer's likelihood of paying off the financial account; and means for determining a course of action regarding the customer based, at least in part, on the score. In another embodiment, an apparatus for selecting a course of action regarding a customer having a financial account may include means for obtaining data indicative of at least one parameter associated with a loan account; means for obtaining data indicative of at least one parameter associated with a customer, wherein the customer is associated with the loan account; means for generating a first weighted score based on the least one parameter associated with the loan account; means for generating a second weighted score based on at least one parameter associated with the customer; means for generating a final score based on the first weighted score and the second weighted score; and means for making a comparison between the final score and a threshold indicative of a likelihood that the customer will payoff the loan account. In a further embodiment, an apparatus for selecting a course of action regarding a customer having a financial account may include means for generating a plurality of parameters associated with a financial account and a customer associated with the loan account; means for generating a weighted score for each of a subset of the plurality of parameters; means for generating a final score based, at least in part, on the weighted scores, wherein the final score is indicative of the customer's likelihood of paying off the financial account; and means for identifying a course of action regarding the customer based, at least in part, on the final score. In a still further embodiment, an apparatus for selecting a course of action regarding a customer having a financial account may include means for obtaining first data associated with a customer having a financial account; means for obtain second data, the second data regarding the financial account; means for generating a score associated with the customer based, at least in part, on the first data and the second data, wherein the score is indicative of the customer's rate of paying off the financial account in a given time period; and means for determining a course of action regarding the customer based, at least in part, on the score. In an even further embodiment, an apparatus for selecting a course of action regarding a customer having a financial account may include means for obtaining data indicative of at least one parameter associated with a loan account; means for obtaining data indicative of at least one parameter associated with a customer, wherein the customer is associated with the loan account; means for generating a first weighted score based on the least one parameter associated with the loan account; means for generating a second weighted score based on at least one parameter associated with the customer; means for generating a final score based on the first weighted score and the second weighted score; and means for making a comparison between the final score and a threshold indicative of the customer paying off the loan account in a given time period. In another embodiment, an apparatus for selecting a course of action regarding a customer having a financial account may include means for identifying a first score associated with a customer based, wherein the first score is indicative of the customer's likelihood of paying off a financial account; means for identifying a second score associated with the customer, wherein the second score is indicative of the customer's rate of paying off the financial account; and means for identifying a course of action regarding the customer based, at least in part, on the first score and the second score.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

FIG. 1 is a flowchart of a first embodiment of a method in accordance with the present invention;

FIG. 2 is a flowchart of a second embodiment of a method in accordance with the present invention;

FIG. 3 is a flowchart of a third embodiment of a method in accordance with the present invention;

FIG. 4 is a block diagram of system components for an embodiment of an apparatus usable with the methods of FIGS. 1-3;

FIG. 5 is a block diagram of components for an embodiment of an account manager of FIG. 4;

FIG. 6 is an illustration of a representative customer information database of FIG. 5;

FIG. 7 is an illustration of a representative account information database of FIG. 5; and

FIG. 8 is an illustration of a representative contract information database of FIG. 5.

### DETAILED DESCRIPTION

Applicants have recognized that there is a need for systems, means, computer code and methods that facilitate predicting or otherwise determining a customer's likelihood of paying off a financial account and predicting the amount of time a customer might take to pay off the financial account.

A customer's likelihood of paying off a financial account by reducing the account balance to zero or near-zero in the near future (e.g., within the next twelve months) may be predicted or otherwise determined by analyzing various variables (also referred to herein as parameters) associated with the customer and/or the account. As a result, active customer retention efforts or activities may be undertaken or conducted, particularly for the most profitable customers. Different retention efforts may be taken for different customers or for customers exhibiting different likelihoods or rates of paying of a financial account. For example, customer expected to pay off a financial account in two months may receive more attention than a customer that is not expected to pay off a financial account for nine months. In other to retain the customer, more direct or aggressive marketing efforts or promotional activities may be directed to the first customer in comparison to the second customer.

For example, variables associated with the customer may be or include a number of people in the customer's household, the customer's job or occupation, the customer's credit rating or history, the customer's age, the customer's income, the number of loans the customer has in effect, etc. Variables associated with an account may be or include the age of the account (usually measured in months), the average balance over a time period (e.g., six months) in the account, the number of withdrawals made from the account, the average size of withdrawals from the account, the average payment made to the account over a time period (e.g., six months), the interest rate associated with the account, the maximum loan withdrawal allowed in the account, the minimum monthly payment required for the account, etc. Of course, other factors or variables may be taken into account in some embodiments.

Information regarding variables may be received from different sources, such as, for example, credit bureaus, loan agencies, lenders, census agencies, etc. A score may be computed based on the parameters, which is indicative of the customer's likelihood of paying off the financial account. In addition, if a customer is deemed likely to pay off a financial account, a likely rate of the customer's pay off may be determined. For example, two customers may be expected to pay off their respective financial accounts in twelve months. The first customer may maintain a large balance in his financial account for the first eleven months and then pay off the entire large balance during the last month. In contrast, the second customer may pay off almost the entire balance of her loan account during the first month, maintain a low balance in the account for ten months, and then pay off the financial account during the last month. One way to distinguish the two customers is too look at the curve of their balances over a period of time. For example, at a given moment, a payoff indicator for a customer's financial account may be based on the area under the curve of the customer's account balance over time divided by the customer's outstanding balance for a financial account at the given moment. Such a formulation helps to normalize scoring between financial accounts having different contract amounts or allowable balances. The smaller the value of the indicator for a financial account, the lesser the expected time to pay off of the financial account. Until the last month, this payoff indicator formula for the first customer would be higher than the payoff indicator for the second customer, thereby indicating that, in all likelihood, the first customer is less likely to pay off his financial account than the second customer. While the pay off time indicator formula may be helpful in some situations, it may not adequately predict the pay off rate of the first customer relative to the second customer and so more sophisticated models may be needed.

A score may be or include a numerical determination, alphabetical or other ranking, or other evaluation metric or result. Once the score is computed, it may be used to select or otherwise determine one or more courses of actions (e.g., customer retention marketing or other promotional activities) to take regarding the customer and/or the account. For example, a customer who is not considered likely to payoff an account may not have additional retention marketing efforts directed to him or her. In contrast, a customer who is likely to payoff an account may have marketing efforts directed to him or her in an attempt to persuade the customer to continue using the account. Alternatively, a customer who is likely to payoff an account may have marketing efforts directed to him or her in an attempt to persuade the customer to establish a different financial account, a credit card, etc. so that interest or other payments may be received from the customer via other financial products. Thus, marketing activities directed toward the customer can be coordinated or integrated more efficiently and effectively.

These and other features will be discussed in further detail below, by describing a system, individual devices, and processes according to embodiments of the invention.

Process Description

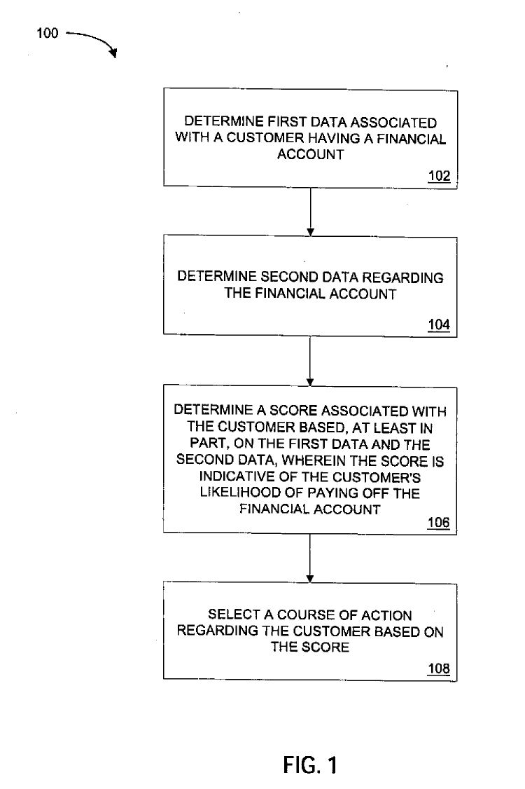

Reference is now made to FIG. 1, where a flow chart 100 is shown which represents the operation of a first embodiment of the present invention. The particular arrangement of elements in the flow chart 100 is not meant to imply a fixed order to the steps; embodiments of the present invention can be practiced in any order that is practicable. In some embodiments, some or all of the steps of the method 100 may be performed or completed by a server, user device and/or another device, as will be discussed in more detail below.

Processing begins at a step 102 during which data is received or otherwise determined that associated with a customer having a financial account. In some embodiments, information regarding one or more customers may be stored in or accessed from a customer information database.

The data received or determined during the step 102 may be part of, or included in, an email message, instant message communication, radio transmission, facsimile transmission, Web page download, database retrieval, FTP (file transfer protocol) transmission, XML (extensible markup language) feed, HTML (Hypertext Markup Language) transmission, or other electronic signal or communication or via some other communication channel.

The financial account may be established via contract or other agreement between an entity (e.g., bank or other lender) and the customer. The financial account may have a maximum loan amount, interest rate, minimum monthly payment, or other term or condition associated with it. In some embodiments, the financial account may be secured or unsecured.

In some implementations, a customer may be able to withdraw money from the financial account by using a kiosk, ATM, or the monetary dispensing/receiving device. Alternatively, the customer may make withdrawals via a bank, wire transfer, etc. In addition, the customer may be able to make payments via the dispensing/receiving device or via wire transfer, bank deposit, mail-in payment, etc.

The data associated with the customer that is determined during the step 102 may be or include demographic information pertaining to the customer. For example, such demographic information may be or include the customer's age, income, occupation, occupation type or category, marital status, household size, length of time in current job, etc. In addition, in some embodiments, the data determined during the step 102 may include information regarding one or more additional financial accounts established by or for the customer, one or more transactions involving the customer, etc.

In some embodiments, the data determined during the step 102 may be or include information regarding other one or more additional sources of income for the customer. For example, a customer may be entitled to, or be expected to, receive a bonus or other payment from the customer's employer. In some embodiments, an entity establishing a loan account with the customer may require or expect that the customer make some minimum payment (e.g., interest payments) to the account on a regular basis (e.g., once a month). If the customer is expected or entitled to receive a bonus from his or her employer, the entity may establish a separate loan account for the customer that is tied to the bonus. Such a loan account is referred to herein as a bonus account. For example, suppose a customer will receive a bonus twice a year from the customer's employer. The bonus account may require or expect that the customer make payments to the loan account twice a year in the months that coincide with the months that the customer is receiving the bonuses. Typically, the entity may not establish a bonus account with the customer unless the entity already has another loan account with the customer or unless the entity has some other relationship with the customer from which to judge the merits of establishing a bonus account for the customer. Bonus accounts are used in some countries such as Japan. A bonus account variable may be indicative of how many bonus accounts the customer has opened or will open in a time period. Alternatively, a bonus account variable may be indicative that the customer has bonus accounts, the total balance associated with the bonus accounts, the total available credit line associated with the bonus accounts, etc. Information regarding a bonus account associated with a customer may be determined or obtained when the customer enters an agreement to establish the bonus account. In addition, information regarding a bonus account for a customer may be obtained after the customer has opened an original financial account that is not tied to a bonus the customer expects to receive in the future.

In some embodiments, the data determined during the step 102 may be or include information regarding a credit permission category associated with the customer. A credit permission category is or represents awareness of, or agreement by, a customer's family member to the establishment of a financial account for the customer and may be used to evaluate the customer when the customer wants to enter into an agreement to establish the financial account. For example, a spouse of a customer may agree to the establishment of a financial account by the customer. The spouse may then be contacted or notified regarding the financial account if the customer is unavailable.

One or more credit permission categories or bands may be established by an entity implementing the method 100, an entity entering into an agreement with the customer to provide the loan account to the customer, a government agency, or some other entity. In some embodiments, a credit permission category associated with a customer may be or include the following:

| | |
|---|---|
| Category 1 | Confidential |
| Category 2 | Agreed by spouse |
| Category 3 | Agreed by father |
| Category 4 | Agreed by mother |
| Category 5 | Agreed by siblings |
| Category 6 | Agreed by all members of family |
| Category 7 | Agreed by parents |

For example, the credit permission category 1 of “Confidential” may mean or represent that no one other than the customer is aware of the financial account while the credit permission category 2 of “Agreed by spouse” means or represents that the customer's spouse is aware of; and may have agreed to, the financial account.

In some embodiments, the data determined during the step 102 may include information regarding a job type associated with the customer and may provide information regarding a nature of the customer's occupation. Information regarding a customer's job type may be determined when the customer enters into an agreement to establish a financial account. One or more job types may be established by a governmental agency, an entity implementing the method 100, an entity providing a financial account to a customer, etc. In some embodiments, a job type associated with a customer may be or include the following:

| | |
|---|---|
| Job Type 0 | Missing or Non Registered |
| Job Type 1 | Executive |
| Job Type 2 | Managerial |
| Job Type 3 | Shop Owner/Private Company Owner |
| Job Type 4 | Expert/Engineer |
| Job Type 5 | Administrative |
| Job Type 6 | Outside Office |
| Job Type 7 | Operator |
| Job Type 8 | Salesperson |
| Job Type 9 | Traveling Salesperson |
| Job Type 10 | Mediator |
| Job Type 11 | Route Salesperson |
| Job Type 12 | Consumer Service |
| Job Type 13 | Laborer |

In some embodiments, the data determined during the step 102 may be or include information regarding a credit history, credit rating and/or credit trend associated with the customer.

In some embodiments, the data determined during the step 102 may be or include information regarding a customer's loan channel or most frequently used loan channel (i.e., the avenue by which the customer receives funds or makes a loan from the account). In some embodiments, a loan channel or most frequently used loan channel for a customer may be designated as follows:

| | |
|---|---|
| Channel Type 1 | Other |
| Channel Type 2 | Mail |
| Channel Type 3 | Bank Transfer |
| Channel Type 4 | Collection |
| Channel Type 5 | Automatic Teller Machine (ATM) |
| Channel Type 6 | Direct Debit |
| Channel Type 7 | Branch |

In some embodiments, a loan channel for a customer may be related to or the same as how the customer receives compensation or salary.

In some embodiments, the data determined during the step 102 may be or include information regarding a credit history, credit rating and/or credit trend associated with the customer. In addition, in some embodiments, the data determined during the step 102 may include information regarding one or more additional loans or other financial accounts associated with one or more customers, the balances in the accounts, any delinquencies associated with the accounts, etc. This information may be provided by one or more credit bureaus, banks, lenders, etc.

In some embodiments, the data determined during the step 102 may be or include information regarding insurance or insurance category or categories associated with the customer. An insurance category for a customer is or may represent the type of insurance the customer is covered under. Information regarding a customer's insurance or insurance category may be determined when the customer enters into an agreement to establish a financial account or the customer enters into a new contract for an existing financial account. For example, the customer may be asked questions regarding insurance coverage whenever the customer establishes or changes an account. The insurance or insurance categories may be established by a governmental agency, an entity implementing the method 100, an entity providing loan account to a customer, etc. and may be or include the following:

| | |
|---|---|
| Category 0 | Not registered |
| Category 1 | Social |
| Category 2 | Union |
| Category 3 | Mutual Aid |
| Category 4 | National |
| Category 5 | Construction |
| Category 6 | Seamens |
| Category 7 | Other |

For example, the category 0 of “Not registered” means or represents that the customer does not have insurance while the category 4 of “National” means or represents that the customer is provided with insurance by or from a government agency or organization and the category 2 of “Union” means or represents that the customer is provided with insurance by or from a union organization (e.g., teachers' union, electricians' union). The “Construction” and “Seamens” categories are industry groups or associations that may provide or sell insurance to members.

In some embodiments, the data determined during the step 102 may include information regarding one or more agreements in effect that are associated with the customer. The agreements may be revolving agreements or non-revolving agreements.

Data received during the step 102 may be received as part of other types of data received by an entity or a device. For example, during the step 102, a device or entity implementing the step 102 may receive data regarding demographic or social information, credit information, account history information, contract information, information regarding other accounts or transactions, payment history information, delinquency information, for one or more customers.

Data received during the step 102 may come from one or more sources. For example, a device or entity implementing the step 102 may receive data from lenders, employers, census bureaus or agencies, credit bureaus, transaction participants, databases, etc. Alternatively, an entity or device implementing the step 102 may develop, ascertain, generate, etc. some or all of the data itself. Different types of data may be received or otherwise determined at different times during the step 102, received via different communication channels, received from different sources, etc.

During a step 104, data is received or otherwise determined regarding the financial account associated with the customer involved in the step 102. In some embodiments, the step 104 may be initiated or completed simultaneously with the step 102, as part of the step 102, or before the step 102. Thus, in some embodiments, the steps 102 and 104 may be initiated or completed as a single step. In some embodiments, information regarding one or more financial accounts may be stored in or accessed from a financial account information database.

The data received or determined during the step 104 may be part of, or included in, an email message, instant message communication, radio transmission, facsimile transmission, Web page download, database retrieval, FTP transmission, XML feed, HTML transmission, or other electronic signal or communication or via some other communication channel.

In some embodiments, data regarding a financial account may be or include information regarding the interest rate, minimum monthly payment, maximum allowable balance, etc. associated with the account. As other examples, in some embodiments, the data determined during the step 104 may be or include information regarding the number of payments made toward the balance of a financial account during a designated time period (e.g., previous six months, previous three months), the number of decreases or increases in a balance of a financial account during a time period or observation window (e.g., previous six months), a number of loans or withdrawals made by a customer during a designated time period (e.g., previous six months, previous three months), information regarding at least one delinquent payment associated with the financial account, information regarding a number of delinquent payments made to the financial account during a time period, etc.

In some embodiments, the data determined during the step 104 may include information regarding the percentage of a customer's credit line available for loan to the customer, referred to herein as the remaining credit line ratio. The higher the current remaining credit line ratio for an account, the lower the current balance in the account. As one example of how a remaining credit line ratio might be calculated, assume that a customer has a loan account that allows a maximum loan amount of ten thousand dollars ($10,000). Thus, the customer has a credit line often thousand dollars. The customer's remaining credit line ratio may be calculated as follows: (the credit limit of the account minus the balance of the account) divided by the credit limit of the account, or (account credit limit minus account balance)/(account credit limit). If the customer has borrowed four thousand dollars ($4,000) via the account, the customer's remaining credit line ratio is ($10,000-$4,000)/$10,000 or 0.6.

In some embodiments, the data determined during the step 104 may be or include information regarding a minimum credit utilization ratio for a financial account and a given time period. For example, a minimum credit utilization ratio for an account during a three month time period may be the minimum of multiple credit utilization ratios measured for the account over the three month time period. A credit utilization ratio may be determined for the account once per day, once per week, once per month, etc. during the three month time period. The minimum credit utilization ratio for the three month time period will be the lowest of these determined credit utilization ratios.

In some embodiments, the data determined during the step 104 may be or include information regarding a minimum remaining credit line ratio for a financial account and a given time period. For example, a minimum remaining credit line ratio for an account during a three month time period may be the minimum of multiple remaining credit line ratios measured for the account over the three month time period. A remaining credit utilization line ratio for an account may be determined for the account once per day, once per week, once per month, etc. during the three month time period. The minimum remaining credit line ratio for the three month time period will be the lowest of these determined remaining credit line ratios.

In some embodiments, the data determined during the step 104 may be or include information regarding an average balance reduction associated with the financial account. For example, an average balance reduction for a financial account may be or include information regarding the average balance reduction for the financial account over a time period (e.g., three months, six months).

In some embodiments, the data determined during the step 104 may include information regarding an account age associated with the financial account. An account age for a financial account may be or include the time in days, weeks, months, etc. since the account was established, contractually agreed to, first used, etc.

In some embodiments, the data determined during the step 104 may include information regarding one or more loan channels (e.g., bank draft, automatic teller machine) used to obtain a loan from a financial account.

Data received or otherwise determined during the step 104 may be received as part of other types of data received by an entity or a device. For example, during the step 104, a device or entity implementing the step 104 may receive data regarding demographic or social information, credit information, account history information, contract information, information regarding other accounts or transactions, payment history information, delinquency information, for one or more customers.

Data received or otherwise determined during the step 104 may come from one or more sources. For example, a device or entity implementing the step 104 may receive data from lenders, census bureaus or agencies, credit bureaus, transaction participants, databases, etc. Alternatively, an entity or device implementing the step 104 may develop, ascertain, generate, etc. some or all of the data itself. In some embodiments the data determined during the step 104 (and/or the step 102) may include information regarding when, where, how, etc. a customer makes payments or withdrawals regarding the account. Different types of data may be received or otherwise determined at different times during the step 104, received via different communication channels, received from different sources, etc.

During a step 106, a rating, evaluation, ranking, estimation, valuation, assessment, appraisal, indicator, predictor, judgment, etc. (hereafter referred to as a “score”) is computed or otherwise determined that is associated with the customer and based, at least in part, on the data determined during the steps 102 and 104. The score may be indicative of the customer's likelihood of paying off a financial account in the future.

A score may be or include a numerical determination or representation, category or level determination (e.g., different categories or levels indicate different likelihoods of a customer paying off a financial account), formula or metric result, requirement(s) check or assessment, model result, letter rating, etc. and be determined in accordance with an algorithm, model, heuristic, procedure, expert system, rule, etc. Thus, in some embodiments, determining a score may be or include determining a category or level a customer is in, comparing data regarding the customer and/or an account associated with the customer with different indicators or predictors of a customer's later action, using data regarding the customer and/or an account associated with the customer to create an assessment or a prediction of the customer's likelihood of paying off a financial account, etc. In some embodiments, information regarding one or more scores or scoring algorithms, models, etc. may be stored in or accessed from a score or scoring information database.

As one example of how a scoring system might be used for a financial account (assumed to be a loan account for purposes of this example), the following variables might be used to determine a score for a customer having or associated with the account, the score being indicative of a propensity of the customer to payoff the financial account: (1) average balance reduction over three months of the account; (2) change of credit usage in last six months; (3) contract amount at cutting point; (4) customer age at cutting month; (5) difference between number of balance increases during previous six months and number of balance decreases during previous six months; (6) job type associated with the customer; (7) minimum of credit usage in last three months; (8) number of loans taken in observation period or window (e.g., three months, six months); (8) variation of Lender Exchange number during previous six months; and (9) variation of Lender Exchange amount during previous six months. For an entity providing a loan or other to a customer, a Lender Exchange amount for the customer reflects the total amount of loans from other lenders other than the entity provided to the customer. The LE number represents the number of loans provided to the customer by the other lenders.

Each of these variables will be discussed in more detail below. Each of these variables may have multiple variable categories. The final score may be the sum of these category variable values or by the weighted versions of these category variable values. For purposes of these example, the customer will be assumed to be in Japan, to receive an annual salary in Yen, and to have established an agreement that establishes an interest rate, maximum balance, etc. for a loan account.

A Lender Exchange is a credit bureau that, among other things, may monitor and record the number, type, balances, etc. of loans associated with customers and may provide information regarding the number of loans associated with a customer that have positive or negative balances. For an entity implementing the method 100 and operating a financial account for a customer, a Lender Exchange may provide information regarding the number and total current balance of financial accounts established for the customer by other lenders or entities.

Information regarding the fourteen variables may be received during the step 102 and/or the step 104 or derived from the information and other data received during the step 102 and/or 104. The information and other data regarding the fourteen variables also may be received for a time period prior to the current implementation of the step 106. Thus, the method 100 may use data regarding an accounts and/or a customer generated over time to predict what the customer will do with the account in the future. For purposes of this example, data will be calculated relative to a cutting point. In general, any previously generated or available data for an account and/or customer may be used. For purposes of the following example, information from as early as six months before the cutting point may be used for some variables.

Average Balance Reductions Over Three Months

For purposes of this example, the average balance reductions over three months variable may relate to an average balance reduction trend over three months variable AVTRND3. The variable AVTRND3 may be computed as follows: If an account is less than three months old, AVTRND3 is considered “missing”. If the account is three months old or older and the number of balance reductions in the account over the past three months (RED3) is zero, then AVTRND3 equals zero.

If the account is three months old or older and the number of balance reductions over the past three months in the account (RED3) is greater than zero, then AVTRND3 is computed as follows: AVTRND3 equals SUM (BALTRND4 to BALTREND6) divided by RED3, where:

BALTRND(i) where i=4 to 6 is calculated as follows:

If BALANCE(i)=0, then BALTRND(i)=0;

Otherwise
BALTRND(i)=[balance(i)−balance(i+1)]/balance(i);

If BALTRND(i)<0 then BALTRND(i)=0.

BALANCE(4) is the balance in the account three months before the cutting point,

BALANCE(5) is the balance in the account two months before the cutting point,

BALANCE(6) is the balance in the account one months before the cutting point, etc.

The average account balance reduction over three months variable may be set up into four categories or bands as follows:

D1AVTRN3 equals one if AVTRND3<=0.1, or is “missing” else D1AVTRN3 equals zero.

D2AVTRN3 equals one if 0.1<AVTRND3<=0.03, else D2AVTRN3 equals zero.

D3AVTRN3 equals one if 0.03<AVTRND3<=0.12, else D3AVTRN3 equals zero.

D1AVTRN4 equals one if 0.12<AVTRND3, else D4AVTRN3 equals zero.

Each of the four category variables D1AVTRN3 through D2AVTRN3 may have a different weighting factor associated with it, as will be discussed in more detail below. Only one of the four average account balance reduction category variables will be equal to one while the remaining average balance reduction category variables will be equal to zero.

Change of Credit Usage in Past Six Months

For purposes of this example, the change of credit usage in past six months variable may be set up into six categories or bands as follows:

D1CH_US6 equals one if CH_USAG6 is less than or equal to −77777, else D1CH_US6 equals zero.

D2CH_US6 equals one if CH_USAG6 is greater than −77777 and less than or equal to −0.15, else D2CH_US6 equals zero.

D3CH_US6 equals one if CH_USAG6 is greater than −0.15 and less than or equal to 4.16, else D3CH_US6 equals zero.

D4CH_US6 equals one if CH_USAG6 is greater than 4.16 and less than or equal to −0.1, else D4CH_US6 equals zero.

D5CH_US6 equals one if CH_USAG6 is greater than −0.1 and less than or equal to 0.4, else D5CH_US6 equals zero.

D6CH_US6 equals one if CH_USAG6 is greater than 0.4, else D6CH_US6 equals zero.

CH_USAG6 is or represents a change in credit usage associated with an account over the previous six months period. If the contract amount at the beginning of the six month period is less than not the same as the contract amount at the end of the six month period, then CH_USAG6 is set to −77777. If the contract amount at the beginning of the six month period is more than the contract amount at the end of the six month period, then CH_USAG6 is set to −88888. If the contract amount at the beginning of the six month period is the same as the contract amount at the end of the six month period, then CH_USAG6 equals the current account utilization (e.g., the account utilization at the cutting point) minus the account utilization six months ago. As previously discussed above, the account utilization at a given time may be calculated by dividing the balance of the account at the time by the loan or contract amount at the time.

Each of the six category variables D1CH_US6 through D6CH_US6 may have a different weighting factor associated with it, as will be discussed in more detail below. Only one of the six category variables will be equal to one while the remaining five category variables will be equal to zero.

Contract Amount at Cutting Month

For purposes of this example, the contract amount variable may be set up into three categories or bands as follows:

D1CNT_AM equals one if the customer's contract amount (i.e., the maximum the customer is allowed to borrow from the account) at the cutting point is less than or equal to three hundred thousand YEN, else D1CNT_AM equals zero.

D2CNT_AM equals one if the customer's contract amount at the cutting point is greater than three hundred thousand Yen and is less than or equal to five hundred thousand Yen, else D2CNT_AM equals zero.

D3CNT_AM equals one if the customer's contract amount at the cutting point is greater than five hundred thousand Yen, else D3CNT_AM equals zero.

Each of the three category variables D1CNT_AM through D3CNT_AM may have a different weighting factor associated with it, as will be discussed in more detail below. Only one of the three contract amount category variables will be equal to one at a time while the remaining contract amount category variables will be equal to zero.

Customer Age (in Years) at Cutting Month

For purposes of this example, the customer age variable may be set up into four categories or bands as follows:

D1 CUSAGE equals one if the customer is thirty-two years old or less at the cutting point, else D1CUSAGE equals zero.

D2CUSAGE equals one if the customer is more than thirty-two years old and is less than or equal to thirty-eight years old at the cutting point, else D2CUSAGE equals zero.

D3CUSAGE equals one if the customer is more than thirty-eight years old and is less than or equal to forty-four years old at the cutting point, else D3CUSAGE equals zero.

D4CUSAGE equals one if the customer is more than forty-four years old at the cutting point, else D4CUSAGE equals zero.

Each of the four customer age category variables D1CUSAGE through D4CUSAGE may have a different weighting factor associated with it, as will be discussed in more detail below. Only one of the four customer age category variables will be equal to one at a time while the remaining customer age category variables will be equal to zero.

Difference of Number of Balance Increases and Number of Balance Decreases in Past Six Months

For purposes of this example, this variable may be set up into three categories or bands as follows:

If DREDINC6<=−4, then D1DREDI6 equals one, else D1DREDI6 equals zero.

If −4<DREDINC6<=5, then D2DREDI6 equals one, else D2DREDI6 equals zero.

If DREDINC6>5, then D3DREDI6 equals one, else D3DREDI6 equals zero.

DREDINC6 is equal to the number of account balance increases over the past six months minus the number of account balance reductions over the past six months.

Each of the three category variables D1DREDI6 through D3DREDI6 may have a different weighting factor associated with it, as will be discussed in more detail below. Only one of the three category variables will be equal to one at a time while the other two category variables will be equal to zero.

Job Type

For purposes of this example, the job type variable may be set up into four categories or bands as follows:

If the job type associated with the customer, as described above, is 3, 12 or 13, then D1JOB11 equals one, else D1JOB11 equals zero.

If the job type associated with the customer is 0, 1, 7 or 8, then D2JOB11 equals one, else D2JOB11 equals zero.

If the job type associated with the customer, as described above, is 2, 4, 5, 9, or 11, then D3JOB11 equals one, else D3JOB11 equals zero.

If the job type associated with the customer is 6 or 10, then D4JOB11 equals one, else D4JOB11 equals zero.

Each of the four job type category variables D1JOBTY11 through D4JOB11 may have a different weighting factor associated with it, as will be discussed in more detail below. Only one of the four job type category variables will be equal to one while the other three will be equal to zero.

Minimum of Credit Usage During Past Three Months

For purposes of this example, the minimum credit usage during the past three months for an account be set up into four categories or bands as follows:

If MINCRUS3<=0.55, then D1MINCR3 equals one, else D1MINCR3 equals zero.

If 0.55<MINCRUS3<=0.88, then D2MINCR3 equals one, else D2MINCR3 equals zero.

If 0.88<MINCRUS3<=0.95, then D3MINCR3 equals one, else D3MINCR3 equals zero.

If 0.95<MINCRUS3, then D4MINCR3 equals one, else D4MINCR3 equals zero.

MINCRUS3 is or represents the minimum of the monthly credit usages during the past three months. As previously discussed above, an account's credit utilization or usage at a given time may be calculated by dividing the balance of the account at the time by the maximum allowed loan or contract amount at the time. For purposes of calculating MINCRUS3, the account's credit utilization is computed for each of the three months prior to the cutting point and the MINCRUS3 is equal to the lowest of the three calculations. If the contract amount has become zero during the past three months, then MINCRUS3 is set to 99999999.

Each of the four credit usage category variables D1MINCR3 through D4MINCR3 may have a different weighting factor associated with it, as will be discussed in more detail below. Only one of the four credit usage category variables will be equal to one while the other three will be equal to zero.

Number of Loans Taken During Three Month Observation Period

For purposes of this example, the number of loans taken by a customer from an account during a three month observation period may be set up into five categories or bands as follows:

D1NUMLO3 equals one if NUMLOAN3 equals zero, else D1NUMLO3 equals zero.

D2NUMLO3 equals one if NUMLOAN3 is greater than zero and less than or equal to two, else D2NUMLO3 equals zero.

D3NUMLO3 equals one if NUMLOAN3 is greater than two and less than or equal to four, else D3NUMLO3 equals zero.

D4NUMLO3 equals one if NUMLOAN3 is greater than four and less than or equal to seven, else D4NUMLO3 equals zero.

D5NUMLO3 equals one if NUMLOAN3 is greater than seven, else D5NUMLO3 equals zero.

NUMLOAN3 is or represents the number of loans made from an account during the three month observation window.

Each of the five category variables D1NUMLO3 through D5NUMLO3 may have a different weighting factor associated with it, as will be discussed in more detail below. Only one of the five category variables will be equal to one while the other four will be equal to zero.

Variation in LE Total Amount Over Six Months

For purposes of this example, the variation in LE amount over six months variable may be set up into four categories or bands as follows:

If VLEAMT6<=−99999, then D1VLEAM6 equals one, else D1VLEAM6 equals zero.

If −99999<VLEAMT6<=0.91, then D2VLEAM6 equals one, else D2VLEAM6 equals zero.

If 0.91<VLEAMT6<=1.17, then D3VLEAM6 equals one, else D3VLEAM6 equals zero.

If 1.17<VLEAMT6, then 4VLEAM6 equals one, else A4VLEAM6 equals zero.

VLEAMT6 is or represents the change in total loan amount provided to a customer by other lenders during the six month observation period prior to the cutting point and is computed as follows as the ratio of the current total loan amount to the total loan amount six months ago.

Each of the four category variables D1VLEAM6 through D4VLEAM6 may have a different weighting factor associated with it, as will be discussed in more detail below. Only one of the four category variables will be equal to one at any given time while the other three category variables will be equal to zero.

Variation in LE Average Amount Over Six Months

For purposes of this example, the variation in LE amount over six months variable may be set up into five categories or bands as follows:

If VLPRICE6<=−77777, then D1VLPRI6 equals one, else D1VLPRI6 equals zero.

If −77777<VLPRICE6<=0.77, then D2VLPRI6 equals one, else D2VLPRI6 equals zero.

If 0.77<VLPRICE6<=0.93, then D3VLPRI6 equals one, else D3VLPRI6 equals zero.

If 0.93<VLPRICE6<=1.18, then D4VLPRI6 equals one, else D4VLPRI6 equals zero.

If 1.18<VLPRICE6then D5VLPRI6 equals one, else D5VLPRI6 equals zero.

VLPRICE6 is or represents the change of a customer's average loan amount provided by other lenders during the six month period prior to the cutting point and is computed as a ratio of the current average LE loan amount to the average LE loan amount six months ago.

Each of the five category variables D1VLPRI6 through D4VLPRI6 may have a different weighting factor associated with it, as will be discussed in more detail below. Only one of the five category variables will be equal to one at any given time while the other four category variables will be equal to zero.

Weights For Scoring of Pay Off Propensity

As illustrated above, each of the fourteen variables may have multiple categories or bands associated with them. In addition, each category or band for a variable may have a weight associated with it as illustrated in Table 1.

TABLE 1

| | Category | |
|---|---|---|
| | Variable | |
| Variable | Name | Weight |
| Average Balance Reduction Over | D1AVTRN3 | 0 |
| Past Three Months | | |
| Average Balance Reduction Over | D2AVTRN3 | 0 |
| Past Three Months | | |
| Average Balance Reduction Over | D3AVTRN3 | 0 |
| Past Three Months | | |
| Average Balance Reduction Over | D4AVTRN3 | 1.0544 |
| Past Three Months | | |
| Change of Credit Usage in Last Six | D1CH_US6 | −0.143 |
| Months | | |
| Change of Credit Usage in Last Six | D2CH_US6 | 0 |
| Months | | |
| Change of Credit Usage in Last Six | D3CH_US6 | 0 |
| Months | | |
| Change of Credit Usage in Last Six | D4CH_US6 | 0 |
| Months | | |
| Change of Credit Usage in Last Six | D5CH_US6 | 0 |
| Months | | |
| Change of Credit Usage in Last Six | D6CH_US6 | 0.1457 |
| Months | | |
| Contract Amount at Cutting Month | D1CNT_AM | 0.443 |
| Contract Amount at Cutting Month | D2CNT_AM | 0 |
| Contract Amount at Cutting Month | D3CNT_AM | −0.2959 |
| Customer Age at Cutting Month | D1CUSAGE | 0.3303 |
| Customer Age at Cutting Month | D2CUSAGE | 0.2592 |
| Customer Age at Cutting Month | D3CUSAGE | 0.1166 |
| Customer Age at Cutting Month | D4CUSAGE | 0 |
| Difference in Number of Balance | D1DREDI6 | 0.5478 |
| Increases and Number of Balance | | |
| decreases | | |
| Difference in Number of Balance | D2DREDI6 | 0 |
| Increases and Number of Balance | | |
| decreases | | |
| Difference in Number of Balance | D3DREDI6 | 0 |
| Increases and Number of Balance | | |
| decreases | | |
| Job Type | D1JOB11 | −0.2306 |
| Job Type | D2JOB11 | 0 |
| Job Type | D3JOB11 | 0 |
| Job Type | D4JOB11 | 0.2299 |
| Minimum Credit Usage in Last | D1MINCR3 | 0.4761 |
| Three Months | | |
| Minimum Credit Usage in Last | D2MINCR3 | 0 |
| Three Months | | |
| Minimum Credit Usage in Last | D3MINCR3 | 0 |
| Three Months | | |
| Minimum Credit Usage in Last | D4MINCR3 | −0.0917 |
| Three Months | | |
| Number of Loans Taken During | D1NUMLO3 | 0 |
| Observation Period | | |
| Number of Loans Taken During | D2NUMLO3 | 0 |
| Observation Period | | |
| Number of Loans Taken During | D3NUMLO3 | 0 |
| Observation Period | | |
| Number of Loans Taken During | D4NUMLO3 | 0.0982 |
| Observation Period | | |
| Number of Loans Taken During | D5NUMLO3 | 0 |
| Observation Period | | |
| Variation in LE Amount During | D1VLEAM6 | 0 |
| Previous Six Months | | |
| Variation in LE Amount During | D2VLEAM6 | 0.1519 |
| Previous Six Months | | |
| Variation in LE Amount During | D3VLEAM6 | 0 |
| Previous Six Months | | |
| Variation in LE Amount During | D4VLEAM6 | 0 |
| Previous Six Months | | |
| Variation in LE Amount During | D1VLPRI6 | −0.072 |
| Previous Six Months | | |
| Variation in LE Amount During | D2VLPRI6 | 0.1719 |
| Previous Six Months | | |
| Variation in LE Amount During | D3VLPRI6 | 0 |
| Previous Six Months | | |
| Variation in LE Amount During | D4VLPRI6 | 0 |
| Previous Six Months | | |
| Variation in LE Amount During | D5VLPRI6 | 0 |
| Previous Six Months | | |

As illustrated by the previous chart, some weights may be equal to zero. A zero weight may be indicative of a lack of statistical significance of the weight's associated variable. Since each of the fourteen variables will have one of their categories or bands equal to one and the rest equal to zero, the score for the variables may be equal to the total of the weights corresponding to each non-zero category variable. In some embodiments, one or more category variables illustrated in Table 1 may have a non-zero value but the category variable(s) may not be used to compute the score. For example, in some embodiments, only the category variables D1JOB11 and D4JOB11 may be used from the job type variable category.

As previously discussed above, all of the category variables in Table 1 will have either a value of zero or one. In addition, only one category variable for each variable will have a value of one while the remaining category variables for the variable will have a value of zero. For example, the job type variable has four category variables, namely D1JOB11, D2JOB11, D3JOB11 and D4JOB11, only one of which will be equal to one while the other three are equal to zero. In addition, two of the job type category variables (i.e., D2JOB11 and D3JOB11) have associated weights equal to zero.

Thus, a score for a customer that is indicative of the customer's propensity to payoff a financial account can be found by multiplying the category variable values by the associated weights and summing the total. For example, one possible score is illustrated in Table 2.

TABLE 2

| | | | | Weighted |
|---|---|---|---|---|
| | Category | Category | | Category |
| | Variable | Variable | | Variable |
| Variable | Name | Value | Weight | Score |
| Average Balance | D1AVTRN3 | 0 | 0 | 0 |
| Reduction Over Past | | | | |
| Three Months | | | | |
| Average Balance | D2AVTRN3 | 1 | 0 | 0 |
| Reduction Over Past | | | | |
| Three Months | | | | |
| Average Balance | D3AVTRN3 | 0 | 0 | 0 |
| Reduction Over Past | | | | |
| Three Months | | | | |
| Average Balance | D4AVTRN3 | 0 | 1.0544 | 0 |
| Reduction Over Past | | | | |
| Three Months | | | | |
| Change of Credit | D1CH_US6 | 1 | −0.143 | −0.143 |
| Usage in Last Six | | | | |
| Months | | | | |
| Change of Credit | D2CH_US6 | 0 | 0 | 0 |
| Usage in Last Six | | | | |
| Months | | | | |
| Change of Credit | D3CH_US6 | 0 | 0 | 0 |
| Usage in Last Six | | | | |
| Months | | | | |
| Change of Credit | D4CH_US6 | 0 | 0 | 0 |
| Usage in Last Six | | | | |
| Months | | | | |
| Change of Credit | D5CH_US6 | 0 | 0 | 0 |
| Usage in Last Six | | | | |
| Months | | | | |
| Change of Credit | D6CH_US6 | 0 | 0.1457 | 0 |
| Usage in Last Six | | | | |
| Months | | | | |
| Contract Amount at | D1CNT_AM | 0 | 0.443 | 0 |
| Cutting Month | | | | |
| Contract Amount at | D2CNT_AM | 0 | 0 | 0 |
| Cutting Month | | | | |
| Contract Amount at | D3CNT_AM | 1 | −0.2959 | −0.2959 |
| Cutting Month | | | | |
| Customer Age at | D1CUSAGE | 0 | 0.3303 | 0 |
| Cutting Month | | | | |
| Customer Age at | D2CUSAGE | 1 | 0.2592 | 0.2592 |
| Cutting Month | | | | |
| Customer Age at | D3CUSAGE | 0 | 0.1166 | 0 |
| Cutting Month | | | | |
| Customer Age at | D4CUSAGE | 0 | 0 | 0 |
| Cutting Month | | | | |
| Difference in Number | D1DREDI6 | 1 | 0.5478 | 0.5478 |
| of Balance Increases | | | | |
| and Number of | | | | |
| Balance decreases | | | | |
| Difference in Number | D2DREDI6 | 0 | 0 | 0 |
| of Balance Increases | | | | |
| and Number of | | | | |
| Balance decreases | | | | |
| Difference in Number | D3DREDI6 | 0 | 0 | 0 |
| of Balance Increases | | | | |
| and Number of | | | | |
| Balance decreases | | | | |
| Job Type | D1JOB11 | 0 | −0.2306 | 0 |
| Job Type | D2JOB11 | 1 | 0 | 0 |
| Job Type | D3JOB11 | 0 | 0 | 0 |
| Job Type | D4JOB11 | 0 | 0.2299 | 0 |
| Minimum Credit | D1MINCR3 | 0 | 0.4761 | 0 |
| Usage in Last Three | | | | |
| Months | | | | |
| Minimum Credit | D2MINCR3 | 0 | 0 | 0 |
| Usage in Last Three | | | | |
| Months | | | | |
| Minimum Credit | D3MINCR3 | 1 | 0 | 0 |
| Usage in Last Three | | | | |
| Months | | | | |
| Minimum Credit | D4MINCR3 | 0 | −0.0917 | 0 |
| Usage in Last Three | | | | |
| Months | | | | |
| Number of Loans | D1NUMLO3 | 0 | 0 | 0 |
| Taken During | | | | |
| Observation Period | | | | |
| Number of Loans | D2NUMLO3 | 0 | 0 | 0 |
| Taken During | | | | |
| Observation Period | | | | |
| Number of Loans | D3NUMLO3 | 1 | 0 | 0 |
| Taken During | | | | |
| Observation Period | | | | |
| Number of Loans | D4NUMLO3 | 0 | 0.0982 | 0 |
| Taken During | | | | |
| Observation Period | | | | |
| Number of Loans | D5NUMLO3 | 0 | 0 | 0 |
| Taken During | | | | |
| Observation Period | | | | |
| Variation in LE | D1VLEAM6 | 0 | 0 | 0 |
| Amount During | | | | |
| Previous Six Months | | | | |
| Variation in LE | D2VLEAM6 | 1 | 0.1519 | 0.1519 |
| Amount During | | | | |
| Previous Six Months | | | | |
| Variation in LE | D3VLEAM6 | 0 | 0 | 0 |
| Amount During | | | | |
| Previous Six Months | | | | |
| Variation in LE | D4VLEAM6 | 0 | 0 | 0 |
| Amount During | | | | |
| Previous Six Months | | | | |
| Variation in LE | D1VLPRI6 | 0 | −0.072 | 0 |
| Amount During | | | | |
| Previous Six Months | | | | |
| Variation in LE | D2VLPRI6 | 1 | 0.1719 | 0.1719 |
| Amount During | | | | |
| Previous Six Months | | | | |
| Variation in LE | D3VLPRI6 | 0 | 0 | 0 |
| Amount During | | | | |
| Previous Six Months | | | | |
| Variation in LE | D4VLPRI6 | 0 | 0 | 0 |
| Amount During | | | | |
| Previous Six Months | | | | |
| Variation in LE | D5VLPRI6 | 0 | 0 | 0 |
| Amount During | | | | |
| Previous Six Months | | | | |

The total score (indicating propensity of the customer to payoff the account) for this customer may be found by totaling the weighted category variable scores in the far right hand column of Table 2 and is equal to 0.6919. In some cases, an adjustment or intercept score or amount may be added to increase the total score.

In some embodiments, the step 106 or some other part of the method 100 may include determining a rate at which a customer likely to payoff a financial account. Thus, the method 100 may include determining a propensity of the customer to payoff the financial account, as previously discussed above, and/or the rate at which the customer is likely to payoff the financial account. One example pay off rate indicator that may be used has been discussed above, namely using a curve of a customer's account balances over time and taking, at a given moment, the area under the curve for a given amount of time (e.g., six months, seven months) divided by the customer's balance at the given time to determine an indication of the customer's pay-off rate. In general, the smaller the value of this indicator the lesser is the expected time for the customer to pay off the financial account.

As another example of how a scoring system might be used to determine a payoff rate for a financial account (assumed to be a loan account for purposes of this example), the following variables might be used to determine a score for a customer having or associated with the account, the score being indicative of a payoff rate for a customer paying off the financial account: (1) account utilization at cutting month, (2) account balance at cutting month, (3) contract amount at cutting month, (4) LE amount at cutting month, (5) LE number at cutting month, (6) Variation of LE number during observation period, (7) number of payments made during observation period, (8) number of payoffs to account made during observation period, (9) number of bonus accounts at cutting month, (10) customer gender, (11) most frequent loan channel used by customer, and (12) type of insurance by customer at cutting month. The observation period will be assumed to be the six months prior to the cutting point or cutting month.

Each of these variables will be discussed in more detail below. Each of these variables may have multiple categories. A final score may be indicated by the sum of these category variable values or by the weighted versions of these category variable values. The same assumptions will be used for this example as were used in the example discussed above.

Information regarding the eleven variables may be received during the step 102 and/or the step 104 or derived from the information and other data received during the step 102 and/or 104. The information and other data regarding the nine variables also may be received for a time period prior to the current implementation of the step 106. Thus, the method 100 may use data regarding an accounts and/or a customer generated over time to predict what the customer will do with the account in the future.

Account Utilization

For purposes of this account payoff rate example, the account utilization at cutting month variable will have six categories or bands as follows:

If UTILCP<=0.2, then A1UTILCP equals one, else A1UTILCP equals zero.

If 0.2<UTILCP<=0.48, then A2UTILCP equals one, else A2UTILCP equals zero.

If 0.48<UTILCP<=0.73, then A3UTILCP equals one, else A3UTILCP equals zero.

If 0.73<UTILCP<=0.87, then A4UTILCP equals one, else A4UTILCP equals zero.

If 0.87<UTILCP<=0.99, then A5UTILCP equals one, else A5UTILCP equals zero.

If 0.99<UTILCP, then A6UTILCP equals one, else A6UTILCP equals zero.

UTILCP is or represents the account's contracted amount utilization and may be computed by dividing the balance of the account by contracted amount allowed for the account. Thus, an account having a current loan of 200,000 Yen and a current balance of 50,000 Yen would have a current utilization of twenty-five percent.

Each of the six category variables A1UTILCP through A6UTILCP may have a different weighting factor associated with it, as will be discussed in more detail below. Only one of the six category variables will be equal to one at any given time while the other five category variables will be equal to zero.

Account Balance at Cutting Month

For purposes of this account payoff rate example, the account balance at cutting point variable will have five categories or bands as follows:

If BALCUR0<=70,000 Yen then A1BALCUR0 equals one, else A1BALCUR0 equals zero.

If 70,000 Yen<BALCUR0<=270,000 Yen then A2BALCUR0 equals one, else A2BALCUR0 equals zero.

If 270,000 Yen<BALCUR0<=480,000 Yen then A3BALCUR0 equals one, else A3BALCUR0 equals zero.

If 480,000 Yen<BALCUR0<=550,000 Yen then A4BALCUR0 equals one, else A4BALCUR0 equals zero.

If 550,000 Yen<BALCUR0, then A5BALCUR0 equals one, else A5BALCUR0 equals zero.

BALCUR0 equals the current account balance (measured in Yen) for the customer at the cutting point.

Each of the five category variables A1AVTRND6 through A5AVTRND6 may have a different weighting factor associated with it, as will be discussed in more detail below. Only one of the five category variables will be equal to one at any given time while the other four category variables will be equal to zero.

Contract Amount at Cutting Month

A contract amount (referred to herein as “CNT_AMT”) for a financial account represents the maximum allowable loan or balance that the customer may have for the account. For purposes of this account payoff rate example, the contract amount at cutting point variable will have five categories or bands as follows:

If CNT_AMT<=300,000 Yen, then A1CNT_AMT equals one, else A1CNT_AMT equals zero.

If 300,000 Yen CNT_AMT<=500,000 Yen, then A2CNT_AMT equals one, else A2CNT_AMT equals zero.

If 500,000 Yen<CNT_AMT<=550,000 Yen, then A3CNT_AMT equals one, else A3CNT_AMT equals zero.

If 550,000 Yen<CNT_AMT<=580,000 Yen, then A4CNT_AMT equals one, else A4CNT_AMT equals zero.

If 580,000 Yen<CNT_AMT, then A5CNT_AMT equals one, else A5CNT_AMT equals zero.

Each of the five category variables A1CNT_AMT through A1CNT_AMT may have a different weighting factor associated with it, as will be discussed in more detail below. Only one of the five category variables will be equal to one at any given time while the other four category variables will be equal to zero.

LE Amount at Cutting Month

For purposes of this account payoff rate example, the LE amount at cutting month variable will have four categories or bands as follows:

If LEAMTCP<=2, then A1LEAMTCP equals one, else A1LEAMTCP equals zero.

If 2<LEAMTCP<=395, then A2LEAMTCP equals one, else A2LEAMTCP equals zero.

If 395<LEAMTCP<=1170, then A3LEAMTCP equals one, else A3LEAMTCP equals zero.

If 1170<LEAMTCP, then A4LEAMTCP equals one, else A4LEAMTCP equals zero.

LEAMTCP is or represents the total amount of loans provided to a customer by other vendors and may be obtained from the Lender Exchange (e.g., a credit bureau).

Each of the four category variables A1LEAMTCP through A4LEAMTCP may have a different weighting factor associated with it, as will be discussed in more detail below. Only one of the four category variables will be equal to one at any given time while the other three category variables will be equal to zero.

LE Number at Cutting Month

For purposes of this account payoff rate example, the LE number at cutting month variable will have five categories or bands as follows:

If LENOCP<=0, then A1LENOCP equals one, else A1LENOCP equals zero.

If 0<LENOCP<=1, then A2LENOCP equals one, else A2LENOCP equals zero.

If 1<LENOCP<=2, then A3LENOCP equals one, else A3LENOCP equals zero.

If 2<LENOCP<=4, then A4LENOCP equals one, else A4LENOCP equals zero.

If 4<LENOCP, then A5LENOCP equals one, else A5LENOCP equals zero.

LENOCP is or represents the number of loans from other lenders at the cutting point and may be obtained from the Lender Exchange.

Each of the five category variables A1LENOCP through A5LEANOCP may have a different weighting factor associated with it, as will be discussed in more detail below. Only one of the five category variables will be equal to one at any given time while the other four category variables will be equal to zero.

Variation of LE Number During Six Month Observation Period

For purposes of this account payoff rate example, the variation of LE number during the observation period will have three categories or bands, as follows:

If VLENO6<=0, then A1VLENO6 equals one, else A1VLENO6 equals zero.

If 0<VLENO6<=1, then A2VLENO6 equals one, else A2VLENO6 equals zero.

If 1<VLENO6, then A3VLENO6 equals one, else A3VLENO6 equals zero.

VLENO6 is or represents the current LE number minus the LE number six months earlier.

Each of the three category variables A1VLENO6 through A3VLENO6 may have a different weighting factor associated with it, as will be discussed in more detail below. Only one of the three category variables will be equal to one at any given time while the other two category variables will be equal to zero.

Number of Payments During Six Month Observation Period

For purposes of this account payoff rate example, the number of payments made during the observation period variable will have three categories or bands, as follows:

If the number of payments to the account during the six month observation period is three or less, then A1NOPAY6 equals one, else A1NOPAY6 equals zero.

If the number of payments to the account during the six month observation period is more than three and less than or equal to seven, then A2NOPAY6 equals one, else A2NOPAY6 equals zero.

If the number of payments to the account during the six month observation period is more than seven, then A3NOPAY6 equals one, else A3NOPAY6 equals zero.

Each of the three category variables A1NOPAY6 through A3NOPAY6 may have a different weighting factor associated with it, as will be discussed in more detail below. Only one of the three category variables will be equal to one at any given time while the other two category variables will be equal to zero.

Number of Payoffs to Account During Six Month Observation Period

For purposes of this account payoff rate example, the number of payoffs made during the six month observation period variable will have two categories or bands, as follows:

If the customer has not made any payoffs to the account during the six month observation period, then A1NPOFF equals one, else A1NPOFF equals zero.

If the customer has made one or more payoffs to the account during the six month observation period, then A2NPOFF equals one, else A2NPOFF equals zero.

Each of the two category variables A1NPOFF and A2NPOFF may have a different weighting factor associated with it, as will be discussed in more detail below. Only one of the two category variables will be equal to one at any given time while the other category variable will be equal to zero.

Number of Bonus Accounts at Cutting Month

For purposes of this account payoff rate example, the number of bonus accounts variable will have two categories or bands, as follows:

If the customer has no bonus accounts, then A1BONUS equals one, else A1BONUS equals zero.

If the customer has one or more bonus accounts, then A2BONUS equals one, else A2BONUS equals zero.

Each of the two bonus account number category variables A1BONUS and A2BONUS may have a different weighting factor associated with it, as will be discussed in more detail below. Only one of the bonus account number category variables will be equal to one at any given time while the other will be equal to zero.

Customer Gender

For purposes of this account payoff rate example, the customer gender variable will have two categories: namely MALE and FEMALE. Each of the two gender variables may have a different weighting factor associated with it, as will be discussed in more detail below. Only one of the two gender category variables will be equal to one at any given time while the other will be equal to zero.

Most Frequent Loan Channel Used by Customer

For purposes of this account payoff rate example, the most frequently used loan channel variable will have two categories or bands as follows:

If the most frequently used loan channel for a customer is type “4”, then A1FRQ_LOAN equals one, else A1FRQ_LOAN equals zero.

If the most frequently used loan channel for a customer is not type “4”, then A2FRQ_LOAN equals one, else A2FRQ_LOAN equals zero.

Each of the two category variables A1FRQ_LOAN and A2FRQ_LOAN may have a different weighting factor associated with it, as will be discussed in more detail below. Only one of the two category variables will be equal to one at any given time while the other category variable will be equal to zero.

Type of Insurance by Customer at Cutting Month

For purposes of this account payoff rate example, the type of insurance variable will have two categories or bands, as follows:

If the customer's insurance type is type 4 or type 5, then A1INSUR11 equals one, else A1INSUR11 equals zero.

If the customer's insurance type is not type 4 or type 5, then A21NSUR11 equals one, else A21NSUR11 equals zero.

Each of the two insurance category variables A1INSUR11 and A2INSUR11 may have a different weighting factor associated with it, as will be discussed in more detail below. Only one of the two insurance category variables will be equal to one at any given time while the other insurance category variable will be equal to zero.

Weights For Scoring of Pay Off Rate

As illustrated above, each of the eleven variables may have multiple categories or bands associated with each category or band may have a weight associated with it as illustrated in Table 3.

TABLE 3

| Variable | Category Variable Name | Weight |
|---|---|---|
| Account Utilization | A1UTILCP | −1.36111 |
| Account Utilization | A2UTILCP | −0.4202 |
| Account Utilization | A3UTILCP | 0 |
| Account Utilization | A4UTILCP | 0.3139 |
| Account Utilization | A5UTILCP | 0.43372 |
| Account Utilization | A6UTILCP | 0.61196 |
| Account Balance at Cutting Month | A1BALCUR0 | 0 |
| Account Balance at Cutting Month | A2BALCUR0 | 0.13165 |
| Account Balance at Cutting Month | A3BALCUR0 | 0 |
| Account Balance at Cutting Month | A4BALCUR0 | 0 |
| Account Balance at Cutting Month | A5BALCUR0 | 0 |
| Contract Amount at Cutting Month | A1CNT_AMT | −0.39398 |
| Contract Amount at Cutting Month | A2CNT_AMT | 0 |
| Contract Amount at Cutting Month | A3CNT_AMT | 0 |
| Contract Amount at Cutting Month | A4CNT_AMT | 0 |
| Contract Amount at Cutting Month | A5CNT_AMT | 0 |
| LE Amount at Cutting Month | A1LEAMTCP | 0 |
| LE Amount at Cutting Month | A2LEAMTCP | 0 |
| LE Amount at Cutting Month | A3LEAMTCP | 0 |
| LE Amount at Cutting Month | A4LEAMTCP | 0.2327 |
| LE Number at Cutting Month | A1LENOCP | 0 |
| LE Number at Cutting Month | A2LENOCP | 0 |
| LE Number at Cutting Month | A3LENOCP | 0 |
| LE Number at Cutting Month | A4LENOCP | 0 |
| LE Number at Cutting Month | A5LENOCP | 0.17459 |
| Variation of LE Number during | A1VLENO6 | 0 |
| Observation Period | | |
| Variation of LE Number during | A2VLENO6 | 0 |
| Observation Period | | |
| Variation of LE Number during | A3VLENO6 | 0.19054 |
| Observation Period | | |
| Number of Payments During | A1NOPAY6 | 0 |
| Observation Period | | |
| Number of Payments During | A2NOPAY6 | 0.1255 |
| Observation Period | | |
| Number of Payments During | A3NOPAY6 | 0 |
| Observation Period | | |
| Number of Payoffs During | A1NPOFF | 0.20629 |
| Observation Period | | |
| Number of Payoffs During | A2NPOFF | 0 |
| Observation Period | | |
| Number of Bonus Accounts | A1BONUS | −0.154 |
| Number of Bonus Accounts | A2BONUS | 0 |
| Customer Gender | MALE | −0.23002 |
| Customer Gender | FEMALE | 0 |
| Most Frequent Loan Channel Used | A1FRQ_LOAN | 0.16251 |
| by Customer | | |
| Most Frequent Loan Channel Used | A2FRQ_LOAN | 0 |
| by Customer | | |
| Type of Insurance by Customer at | A1INSUR11 | 0.18927 |
| Cutting Month | | |
| Type of Insurance by Customer at | A2INSUR11 | 0 |
| Cutting Month | | |

As illustrated by the previous chart, some weights may be equal to zero. A zero weight may be indicative of a lack of statistical significance of the weight's associated category variable. Since each of the fourteen variables will have one of their categories or bands equal to one and the rest equal to zero, the score for the variables may be equal to the total of the weights corresponding to the non-zero category variables. In some embodiments, one or more category variables illustrated in Table 3 may have a non-zero weight but the category variable(s) may not be used to compute the score.

As previously discussed above, all of the category variables in Table 3 will have either a value of zero or one. In addition, only one category variable for each variable will have a value of one while the remaining category variables forth variable will have a value of zero.

Thus, a score for a customer that is indicative of the customer's rate of payoff for a financial account can be found by multiplying the category variable values by the associated variable weights and summing the total. For example, one possible score is illustrated in Table 4.

TABLE 4

| | | | | Weighted Category |
|---|---|---|---|---|
| | Category Variable | Category Variable | | Variable |
| Variable | Name | Value | Weight | Score |
| Account Utilization | A1UTILCP | 0 | −1.36111 | 0 |
| Account Utilization | A2UTILCP | 1 | −0.4202 | −0.4202 |
| Account Utilization | A3UTILCP | 0 | 0 | 0 |
| Account Utilization | A4UTILCP | 0 | 0.3139 | 0 |
| Account Utilization | A5UTILCP | 0 | 0.43372 | 0 |
| Account Utilization | A6UTILCP | 0 | 0.61196 | 0 |
| Account Balance at | A1BALCUR0 | 0 | 0 | 0 |
| Cutting Month | | | | |
| Account Balance at | A2BALCUR0 | 1 | 0.13165 | 0.13165 |
| Cutting Month | | | | |
| Account Balance at | A3BALCUR0 | 0 | 0 | 0 |
| Cutting Month | | | | |
| Account Balance at | A4BALCUR0 | 0 | 0 | 0 |
| Cutting Month | | | | |
| Account Balance at | A5BALCUR0 | 0 | 0 | 0 |
| Cutting Month | | | | |
| Contract Amount at | A1CNT_AMT | 0 | −0.39398 | 0 |
| Cutting Month | | | | |
| Contract Amount at | A2CNT_AMT | 0 | 0 | 0 |
| Cutting Month | | | | |
| Contract Amount at | A3CNT_AMT | 0 | 0 | 0 |
| Cutting Month | | | | |
| Contract Amount at | A4CNT_AMT | 1 | 0 | 0 |
| Cutting Month | | | | |
| Contract Amount at | A5CNT_AMT | 0 | 0 | 0 |
| Cutting Month | | | | |
| LE Amount at Cutting | A1LEAMTCP | 0 | 0 | 0 |
| Month | | | | |
| LE Amount at Cutting | A2LEAMTCP | 0 | 0 | 0 |
| Month | | | | |
| LE Amount at Cutting | A3LEAMTCP | 1 | 0 | 0 |
| Month | | | | |
| LE Amount at Cutting | A4LEAMTCP | 0 | 0.2327 | 0 |
| Month | | | | |
| LE Number at Cutting | A1LENOCP | 0 | 0 | 0 |
| Month | | | | |
| LE Number at Cutting | A2LENOCP | 0 | 0 | 0 |
| Month | | | | |
| LE Number at Cutting | A3LENOCP | 1 | 0 | 0 |
| Month | | | | |
| LE Number at Cutting | A4LENOCP | 0 | 0 | 0 |
| Month | | | | |
| LE Number at Cutting | A5LENOCP | 0 | 0.17459 | 0 |
| Month | | | | |
| Variation of LE | A1VLENO6 | 0 | 0 | 0 |
| Number during | | | | |
| Observation Period | | | | |
| Variation of LE | A2VLENO6 | 0 | 0 | 0 |
| Number during | | | | |
| Observation Period | | | | |
| Variation of LE | A3VLENO6 | 1 | 0.19054 | 0.19054 |
| Number during | | | | |
| Observation Period | | | | |
| Number of Payments | A1NOPAY6 | 0 | 0 | 0 |
| During Observation | | | | |
| Period | | | | |
| Number of Payments | A2NOPAY6 | 1 | 0.1255 | 0.1255 |
| During Observation | | | | |
| Period | | | | |
| Number of Payments | A3NOPAY6 | 0 | 0 | 0 |
| During Observation | | | | |
| Period | | | | |
| Number of Payoffs | A1NPOFF | 0 | 0.20629 | 0 |
| During Observation | | | | |
| Period | | | | |
| Number of Payoffs | A2NPOFF | 1 | 0 | 0 |
| During Observation | | | | |
| Period | | | | |
| Number of Bonus | A1BONUS | 1 | −0.154 | −0.154 |
| Accounts | | | | |
| Number of Bonus | A2BONUS | 0 | 0 | 0 |
| Accounts | | | | |
| Customer Gender | MALE | 1 | −0.23002 | 0.23002 |
| Customer Gender | FEMALE | 0 | 0 | 0 |
| Most Frequent Loan | A1FRQ_LOAN | 1 | 0.16251 | 0.16251 |
| Channel Used by | | | | |
| Customer | | | | |
| Most Frequent Loan | A2FRQ_LOAN | 0 | 0 | 0 |
| Channel Used by | | | | |
| Customer | | | | |
| Type of Insurance by | A1INSUR11 | 0 | 0.18927 | |
| Customer at Cutting | | | | |
| Month | | | | |
| Type of Insurance by | A2INSUR11 | 0 | 0 | 0 |
| Customer at Cutting | | | | |
| Month | | | | |

The total score (indicating payoff rate of a customer for the account) for this customer may be found by totaling the weighted category variable scores in the far right hand column of Table 4 and is equal to 0.2658. In some cases, a bias or intercept score may be added to increase the total score.

During a step 108, a course of action is selected or otherwise determined based, at least in part, on one or more of the scores determined during the step 106. In some embodiments, the step 108 may be optional and not used or completed. As previously discussed above, a course of action may include a marketing or promotional activity directed toward or for the benefit of a customer. For example, a customer who is not considered likely to payoff an account may not have additional marketing efforts directed toward him or her. In contrast, a customer who is likely to payoff an account may have marketing efforts directed to him or her in an attempt to persuade the customer to continue to use the loan account. Alternatively, a customer who is likely to payoff a loan account may have marketing efforts directed to him or her in an attempt to persuade the customer to establish a different financial account, a credit card, etc. so that interest or other payments may be received from the customer via other financial products.

In the previous examples, the higher the score determined from Tables 1 and 2, the more likely the customer is to pay off a financial account within twelve months. Customer's can be ranked by their scores to help determine which customers to target with retention marketing promotions. In some cases, the cost of retaining a customer may be used to further evaluate the costs and benefits of retaining the customer or undertaking efforts to retain the customer. In some embodiments, a threshold value may be used to evaluate customers. For example, a customer having a score above the threshold value may be considered to be likely to pay off a financial account within the next twelve months while a customer having a score below the threshold value may be considered to not be likely to pay off a financial account within the next twelve months.

In the previous examples, the lower the score determined from Tables 3 and 4, the faster a customer may be expected to pay off a financial account. Other scores may be indicative of other rates of payoff of the financial account. In general, the lower the score, the shorter the expected time a customer is expected to pay-off a loan or other financial account.

In some embodiments, the method 100 may include receiving or otherwise determining data indicative of the algorithm, model, heuristic, procedure, expert system, rule, etc. to be used during the step 106, providing the score or information regarding the score determined during the step 106 to another party or device, providing information regarding the course of action determined during the step 108 to another party or device, implementing or conducting the course of action determined during the step 108, terminating or closing a financial account, providing any or all of the data determined during the step 102 and/or the step 104 to another party or device, providing any or all of the data used or determined during the step 106 to another party or device, updating a database regarding information regarding a customer, financial account, score, receiving a payment for a financial account, facilitating a withdrawal for a financial account, etc., confirming receipt of the data received during the step 102 and/or the step 104, etc.

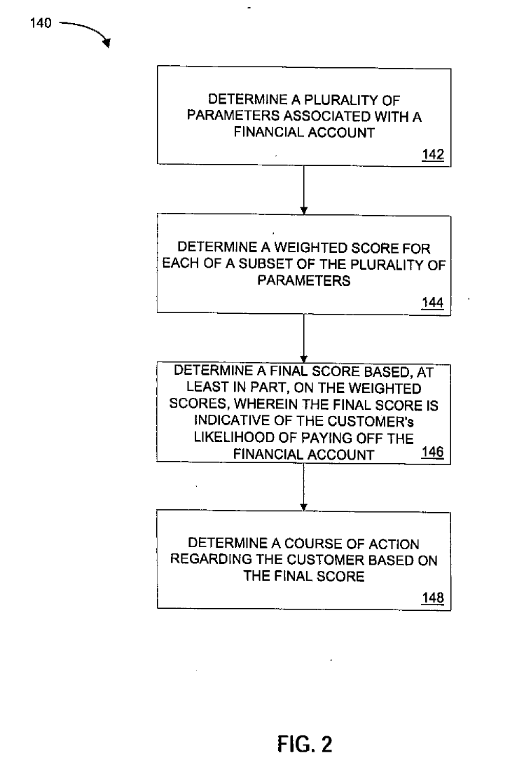

Reference is now made to FIG. 2, where a flow chart 140 is shown which represents the operation of a second embodiment of the present invention. The particular arrangement of elements in the flow chart 140 is not meant to imply a fixed order to the steps; embodiments of the present invention can be practiced in any order that is practicable. In some embodiments, some or all of the steps of the method 140 may be performed or completed by a server, user device and/or another device, as will be discussed in more detail below.

Processing begins at a step 142 during which a plurality of parameters are determined regarding a customer and/or a financial account associated with the customer. The step 142 is similar to the steps 102 and 104 previously discussed above. Information or other data regarding one or more parameters may be received via an electronic signal or communication from one or more sources.

The parameters may include customer and/or financial account data or parameters, such as the parameters previously discussed above. Some or all of the plurality of parameters may be known in advance or identified over time. For example, a model may use one or more parameters that have, over a period of time, been shown to be statistically significant in predicting a customer's actions regarding a financial account (e.g., in predicting whether a customer is likely to payoff a loan account).

During a step 144, a weighted score is determined for each of a subset of the plurality of parameters determined during the step 142. In some embodiments, the subset may be a proper subset of the parameters. In other embodiments, the subset may include all of the parameters determined during the step 142. The weights for particular variables may be used as previously discussed above in Table 2 to create a weighted score.

During a step 146, a final score is determined based on some or all of the weighted parameters determined during the step 144. The step 146 is similar to the step 106 previously discussed above. A final score may be determined in accordance with an algorithm, model, heuristic, procedure, expert system, rule, etc. In some embodiments, the final score may be the total of some or all of the weighted scores determined during the step 144. The score determined during the step 146 may be indicative of a customer's likelihood of paying off the financial account.

During a step 148, a course of action is selected or otherwise determined based, at least in part, on the final score determined during the step 146. The step 148 is similar to the step 108 previously discussed above.

In some embodiments, the method 140 may include receiving or otherwise determining data indicative of the algorithm, model, heuristic, procedure, expert system, rule, etc. to be used during the step 146, providing the score or information regarding the final score determined during the step 146 to another party or device, providing information regarding the course of action determined during the step 148 to another party or device, implementing or conducting the course of action determined during the step 148, terminating or closing a financial account, providing information regarding any or all of the parameters determined during the step 132 to another party or device, updating a database regarding information regarding a customer, financial account, score, etc., providing information regarding one or more of the weighted scores determined during the step 144 to one or more devices or entities, receiving a payment for a financial account, facilitating a withdrawal for a financial account, etc.

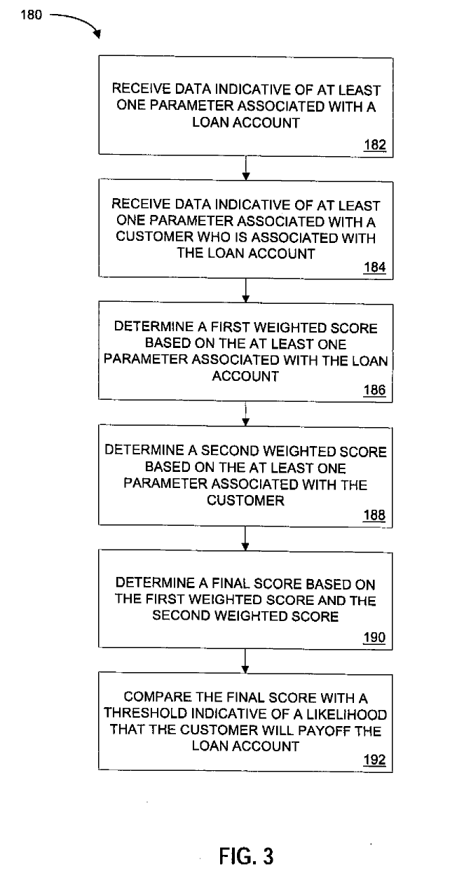

Reference is now made to FIG. 3, where a flow chart 180 is shown which represents the operation of a third embodiment of the present invention. The particular arrangement of elements in the flow chart 180 is not meant to imply a fixed order to the steps; embodiments of the present invention can be practiced in any order that is practicable. In some embodiments, some or all of the steps of the method 180 may be performed or completed by a server, user device and/or another device, as will be discussed in more detail below.

Processing begins at a step 182 during which data is received that is indicative of at least one parameter associated with a loan or other financial account. The step 182 is similar to the steps 104 and 142 previously discussed above.

During a step 184, data is received that is indicative of at least one parameter associated with the loan or other financial account involved in the step 182. The step 184 is similar to the steps 102 and 142 previously discussed above.

In some embodiments, the step 184 may be initiated or completed simultaneously with the step 182, as part of the step 182, or before the step 182. Thus, in some embodiments, the steps 182 and 184 may be initiated or completed as a single step.

During a step 186, a weighted score is determined for at least one of the parameters determined during the step 182. In some embodiments, the step 186 may be initiated or completed prior to or simultaneously with the step 184. The step 186 is similar to that portion of the step 144 previously discussed above dealing with the determination of a weighted score for a parameter associated with a financial account.

During a step 188, a weighted score is determined for at least one of the parameters determined during the step 184. In some embodiments, the step 188 may be initiated or completed prior to or simultaneously with the step 186. The step 188 is similar to that portion of the step 144 previously discussed above dealing with the determination of a weighted score for a parameter associated with a customer.

During a step 190, a final score is determined based, at least in part, on the weighted scores determined during the steps 186 and 188. The step 190 is similar to the step 146 previously discussed above.

During a step 192, a comparison is made with the final score determined during the step 190 with a threshold score indicative of a likelihood that the customer will payoff the financial account. In some embodiments, the step 192 may be optional and not used or completed.

In some embodiments, the method 180 may include a step during which a course of action is selected or otherwise determined based, at least in part, on the final score determined during the step 190 and/or the comparison made during the step 192.

In some embodiments, the method 180 may include receiving or otherwise determining data indicative of the algorithm, model, heuristic, procedure, expert system, rule, etc. to be used during the step 186, the step 188 and/or the step 190, providing the score or information regarding the scores determined during the step 186, the step 188 and/or the step 190 to another party or device, providing information regarding a course of action to another party or device, implementing or conducting a course of action, terminating or closing a financial account, providing information regarding any or all of the parameters determined during the step 182 and/or 184 to another party or device, updating a database regarding information regarding a customer, financial account, score, etc., providing information regarding one or more of the weighted scores determined during the step 186 and/or the step 188 to one or more devices or entities, receiving a payment for a financial account, facilitating a withdrawal for a financial account, confirming receipt of the data received during the step 182 and/or the step 184, etc.

System

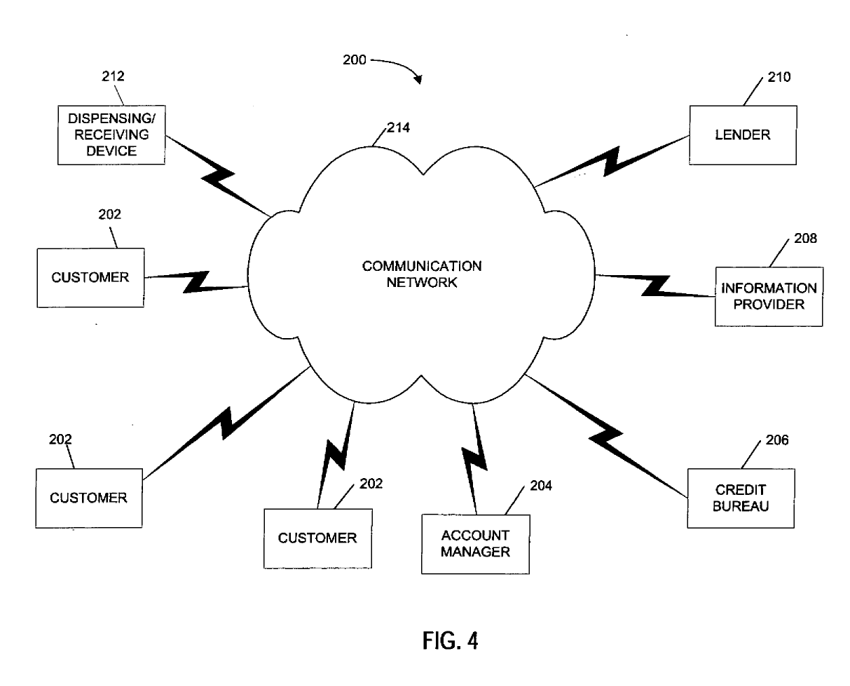

Now referring to FIG. 4, an apparatus or system 200 usable with the methods disclosed herein is illustrated.

The apparatus 200 includes one or more customer (also referred to as customer devices) 202 that may communicate directly or indirectly with an account manager 204 via a computer, data, or communications network 214. In addition, the apparatus 200 may include a credit bureau 206 (also referred to herein as a credit bureau device), an information provider (also referred to herein as an information provider device), a lender (also referred to herein as a lender device), and a dispensing/receiving device 212.

For purposes of further explanation and elaboration of the methods disclosed herein, the methods disclosed herein will be assumed to be operating on, or under the control of, the account manager 204.

The account manager 204 may implement or host a Web site. An account manager device 204 can comprise a single device or computer, a networked set or group of devices or computers, a workstation, etc. In some embodiments, an account manager device 204 also may function as a database server and/or as a user device. The use, configuration and operation of account managers will be discussed in more detail below.

The customer devices 202 preferably allow customers to interact with the account manager 204 and the remainder of the apparatus 200. The customer devices 202 also may enable a user to access Web sites, software, databases, etc. Possible customer devices include a personal computer, portable computer, mobile or fixed user station, workstation, network terminal or server, cellular telephone, kiosk, dumb terminal, personal digital assistant, etc. In some embodiments, information regarding one or more customers and/or one or more customer devices may be stored in, or accessed from, a customer information database and/or a customer device information database.

The credit bureau 206 may provide credit rating or credit history information to the account manager 204 regarding one or more customers on a continuous, periodic, or random basis.

The information provider 208 may be or include any entity that provides information of any kind to the account manager 204 regarding one or more customers and/or one or more accounts. The information provider 208 may provide such information on a continuous, or random basis. In some embodiments, an information provider 208 may be a lender 210 or credit bureau 206.

The lender 210 may provide information to the account manager regarding one or more additional loans or financial products provided to one or more customers. The lender 210 may provide such information on a continuous, or random basis.

The dispensing/receiving device 212 may allow a customer to receive or withdrawal monies or finds from an account or to make one or more payments towards the balance of an account. A dispensing/receiving device 212 may be in communication with a bank, lender or the account manager to ascertain current account balances. A dispensing/receiving device 212 may be or include an ATM (automated teller machine), kiosk or other suitable device.

Many different types of implementations or hardware configurations can be used in the system 200 and with the methods disclosed herein and the methods disclosed herein are not limited to any specific hardware configuration for the system 200 or any of its components. In addition, not all of the parties illustrated in the system 200 may be needed for each embodiment or implementation of the methods disclosed herein.

The communications network 214 might be or include the Internet, the World Wide Web, or some other public or private computer, cable, telephone, client/server, peer-to-peer, or communications network or intranet, as will be described in further detail below. The communications network 214 illustrated in FIG. 4 is meant only to be generally representative of cable, computer, telephone, peer-to-peer or other communication networks for purposes of elaboration and explanation of the present invention and other devices, networks, etc. may be connected to the communications network 214 without departing from the scope of the present invention. The communications network 214 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a customer device or other device may be connected directly to the account manager 204 without departing from the scope of the present invention. Moreover, as used herein, communications include those enabled by wired or wireless technology.

In some embodiments, a suitable wireless communication network 214 may include the use of Bluetooth technology, allowing a wide range of computing and telecommunication devices to be interconnected via wireless connections. Specifications and other information regarding Bluetooth technology are available at the Bluetooth Internet site www.bluetooth.com. In embodiments utilizing Bluetooth technology, some or all of the devices of FIG. 4 may be equipped with a microchip transceiver that transmits and receives in a previously unused frequency band of 2.45 GHz that is available globally (with some variation of bandwidth in different countries). Connections can be point-to-point or multipoint over a current maximum range of ten (10) meters. Embodiments using Bluetooth technology may require the additional use of one or more receiving stations to receive and forward data from individual user devices 202 or servers 204.

The devices shown in FIG. 4 need not be in constant communication. For example, a customer may communicate with the account manager 204 only when such communication is appropriate or necessary.

Server

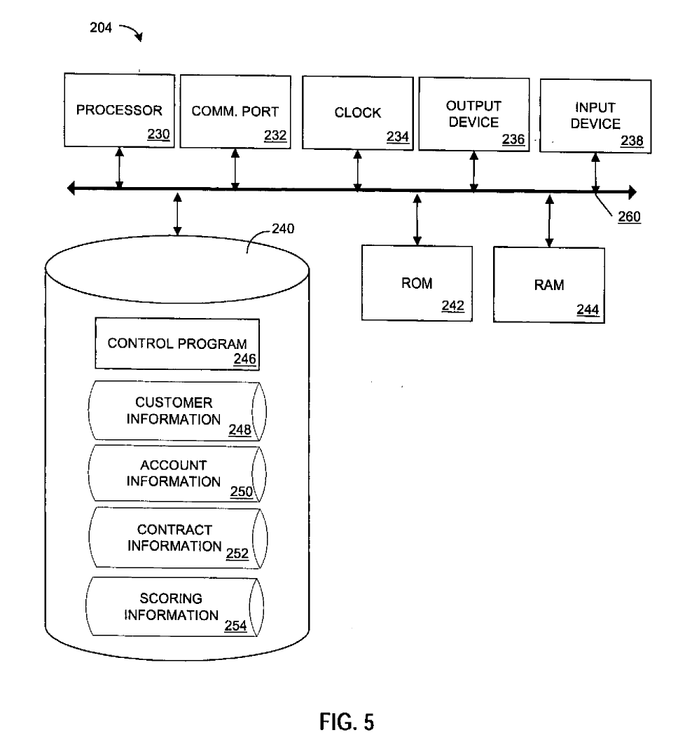

Now referring to FIG. 5, a representative block diagram of an account manager device 204 (hereinafter referred to as a server or controller 204) is illustrated. The server 204 may include a processor, microchip, central processing unit, or computer 230 that is in communication with or otherwise uses or includes one or more communication ports 232 for communicating with user devices and/or other devices. Communication ports may include such things as local area network adapters, wireless communication devices, Bluetooth technology, etc. The server 204 also may include an internal clock element 234 to maintain an accurate time and date for the server 204, create time stamps for communications received or sent by the server 204, etc.

If desired, the server 204 may include one or more output devices 236 such as a printer, infrared or other transmitter, antenna, audio speaker, display screen or monitor, text to speech converter, etc., as well as one or more input devices 238 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 204 may include a memory or data storage device 240 to store information, software, databases, communications, device drivers, customers, factors or other parameters, financial accounts, scores, scoring algorithms, etc. The memory or data storage device 240 preferably comprises an appropriate combination of magnetic, optical and/or semiconductor memory, and may include, for example, Random Read-Only Memory (ROM), Random Access Memory (RAM), a tape drive, flash memory, a floppy disk drive, a Zip™ disk drive, a compact disc and/or a hard disk. The server 204 also may include separate ROM 242 and RAM 244.

The processor 230 and the data storage device 240 in the server 204 each may be, for example: (i) located entirely within a single computer or other computing device; or (ii) connected to each other by a remote communication medium, such as a serial port cable, telephone line or radio frequency transceiver. In one embodiment, the server 204 may comprise one or more computers that are connected to a remote server computer for maintaining databases.

A conventional personal computer or workstation with sufficient memory and processing capability may be used as the server 204. In one embodiment, the server 204 operates as or includes a Web server for an Internet environment. The server 204 may be capable of high volume transaction processing, performing a significant number of mathematical calculations in processing communications and/or database searches. A Pentium™ microprocessor such as the Pentium III™ or IV™ microprocessor, manufactured by Intel Corporation may be used for the processor 230. Equivalent processors are available from Motorola, Inc., AMD, or Sun Microsystems, Inc. The processor 230 also may comprise one or more microprocessors, computers, computer systems, etc.

Software may be resident and operating or operational on the server 204. The software may be stored on the data storage device 240 and may include a control program 246 for operating the server, databases, etc. The control program 246 may control the processor 230. The processor 230 preferably performs instructions of the control program 246, and thereby operates in accordance with the present invention, and particularly in accordance with the methods described in detail herein. The control program 246 may be stored in a compressed, uncompiled and/or encrypted format. The control program 246 furthermore includes program elements that may be necessary, such as an operating system, a database management system and device drivers for allowing the processor 220 to interface with peripheral devices, databases, etc. Appropriate program elements are known to those skilled in the art, and need not be described in detail herein.

The server 204 also may include or store information regarding customers, accounts, contracts, scores scoring algorithms, communications, etc. For example, information regarding one or more customer may be stored in a customer information database 248 for use by the server 204 or another device or entity. Information regarding one or more accounts may be stored in an account information database 250 for use by the server 204 or another device or entity and information regarding one or more contracts may be stored in a contract information database 252 for use by the server 204 or another device or entity. Information regarding one or more scores and/or scoring algorithms may be stored in a scoring information database 254. In some embodiments, some or all of one or more of the databases may be stored or mirrored remotely from the server 204.

According to an embodiment of the present invention, the instructions of the control program may be read into a main memory from another computer-readable medium, such as from the ROM 242 to the RAM 244. Execution of sequences of the instructions in the control program causes the processor 230 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

The processor 230, communication port 232, clock 234, output device 236, input device 238, data storage device 240, ROM 242, and RAM 244 may communicate or be connected directly or indirectly in a variety of ways. For example, the processor 230, communication port 232, clock 234, output device 236, input device 238, data storage device 240, ROM 242, and RAM 244 may be connected via a bus 260.

While specific implementations and hardware configurations for servers 204 have been illustrated, it should be noted that other implementations and hardware configurations are possible and that no specific implementation or hardware configuration is needed. Thus, not all of the components illustrated in FIG. 5 may be needed for a server implementing the methods disclosed herein. Therefore, many different types of implementations or hardware configurations can be used in the system 200 and the methods disclosed herein are not limited to any specific hardware configuration.

Databases

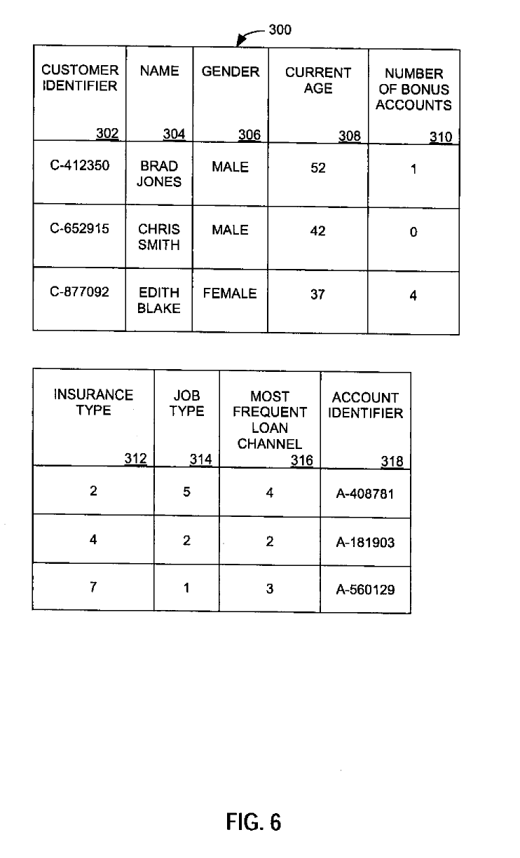

As previously discussed above, in some embodiments a server, user device, or other device may include or access a customer information database for storing or keeping information regarding one or more customer. One representative customer information database 300 is illustrated in FIG. 6.

The customer information database 300 may include a customer identifier field 302 that may include codes or other identifiers for one or more customers, a customer name field 304 that may include names or other descriptive information for the customers identified in the field 300, a gender field 306 that may include information regarding the genders of the customers identified in the field 302, a current age field 308 that may include the current age in years of the customers identified in the field 302, a number of bonus accounts field 310 that may include information regarding bonus accounts, the number of bonus accounts, etc. associated with the customers identified in the field 302, an insurance type field 312 that may include information regarding insurance associated with the customers identified in the field 302, a job type field 314 that may include identifiers or other information regarding one or more job types associated with the customers identified in the field 302, a most frequent loan channel field 316 that may include information regarding the channels of disbursements by the customers identified in the field 302, and an account identifier field 316 that may include identifiers or other information regarding one or more accounts associated with the customers identified in the field 302.

Other or different fields also may be used in the customer information database 300. For example, in some embodiments the customer information database may include address, telephone number, income, credit permission categories, race, marital status, or other demographic or social information for the customers identified in the field 302.

As illustrated by the customer information database 300 of FIG. 6, the customer identified as “C-412350” in the field 302 is named “BRAD JONES”, is male, is “52” years old, has one associated bonus account, an insurance type of “2”, a job type of “5”, and a most frequent loan channel designator of “4”. The customer identified as “C-412350” in the field 302 also is associated with the account identified as “A-408781”.

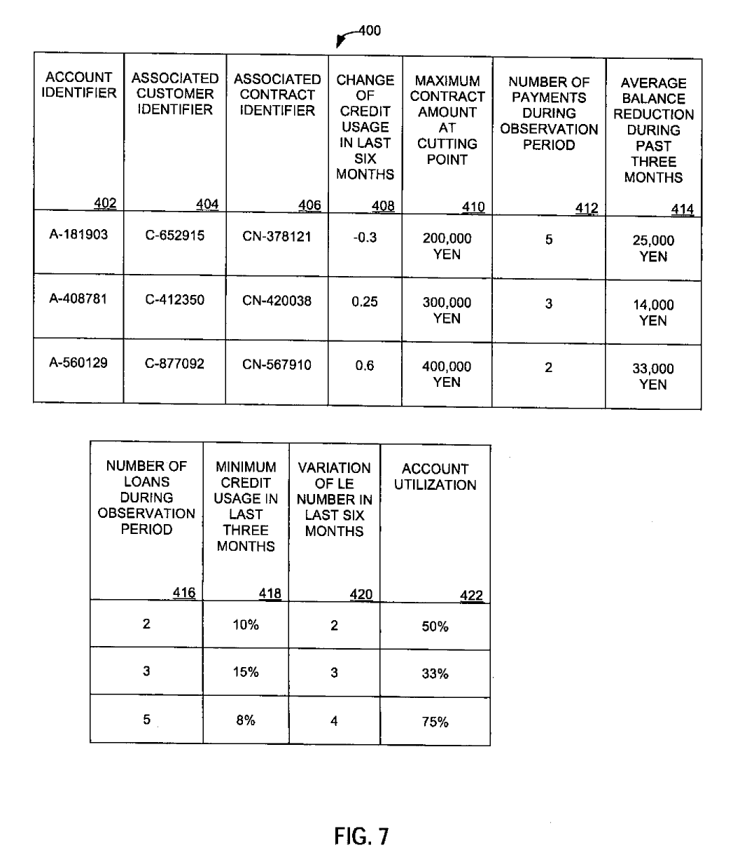

As previously discussed above, in some embodiments a server, user device, or other device may include or access an account information database for storing or keeping information regarding one or more accounts. One representative account information database 400 is illustrated in FIG. 7.

The account information database 400 may include an account identifier field 402 that may include codes or other identifiers for one or more accounts, an associated customer identifier field 404 that may include codes or other identifiers for customers associated with the accounts identified in the field 402, an associated contract identifier field 406 that may include codes or other identifiers for one or more contracts associated with the account identified in the field 402, a change of credit usage in last six months field 408 that may include information regarding the changes of credit usage associated with the accounts identified in the field 402, a maximum contract amount at cutting point field 410 that may include information regarding the maximum contracted loan amount available for the accounts identified in the field 402, a number of loans during the past six months field 412 that may include information regarding the number of payments made during an observation window (assumed to be six months for this example) by the customers identified in the field 404 via the accounts identified in the field 402, an average balance reduction field 414 that may include information regarding the average balance reduction during the previous six months for the accounts identified in the field 402, a minimum credit usage in last three months field 418 that may include information regarding credit usages for the accounts identified in the field 402, a variation of LE number during past six months field 420 that may include information regarding variations in LE numbers associated with the accounts identified in the field 402, and an account utilization ration field 422 that may include information regarding usage of the accounts identified in the field 402.

Other or different fields also may be used in the account information database 400. For example, in some embodiments the account information database 400 may include information regarding when, how and/or where payments are made to an account, information regarding when, how and/or where withdrawals are made from an account, information regarding average payments, information regarding delinquencies or delinquent payments associated with an account, information regarding account age, information regarding the number of balance increases and the number of balance decreases for accounts, information regarding variations in LE amounts for accounts, information regarding payments made to and/or loans made from accounts, etc.

As illustrated by the account information database 400 of FIG. 7, the account identified as “A-181903” in the field 402 is associated with a customer identified as “C-652915” and a contract identified as “CN-378121”. The account identified as “A-181903” has a maximum contract amount of “200,000 YEN”, a current account utilization of “50%”, a change in credit usage in the last sixth months of 0.60, a minimum credit usage in the past three months of “10%”, two loans during the past six months (assuming an observation period of six months prior to the cutting month), an average balance reduction during the past three months of “25,000 YEN” and five payments during the six month observation period.

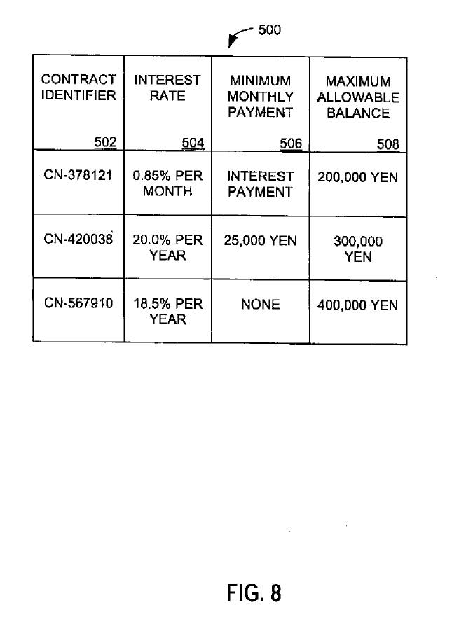

As previously discussed above, in some embodiments a server, user device, or other device may include or access a contract information database for storing or keeping information regarding one or more contracts. One representative contract information database 500 is illustrated in FIG. 8. In some embodiments, a contract information database may be part of or included in an account information database.

The contract information database 500 may include a contract identifier field 502 that may include codes or other identifiers for one or more contracts, an interest rate field 504 that may include information regarding interest rates associated with the contracts identified in the field 502, a minimum monthly payment field 506 that may include information regarding minimum monthly payments required for the contracts identified in the field 502, and a maximum allowable balance field 508 that may include information regarding the maximum sizes of loans that can be made via the contracts identified in the field 502.

Other or different fields also may be used in the contract information database 500. For example, in some embodiments a contract information database may include information regarding when a contract was established, information regarding a maximum term associated with a loan, information regarding collateral if a contract provides for a secured loan, information regarding one or more banks, customers, lenders or other entities associated with the contracts identified in the field 502, information regarding, current account balances, account usage statistics, etc.

As illustrated by the contract information database 500 of FIG. 8, the contract identified as “CN-691552” in the field 502 has an interest rate of “18.5% PER YEAR”, no minimum monthly payment, and a maximum allowable balance of “400,000 YEN” associated with it.

As previously discussed above, in some embodiments a server, user device, or other device may include or access a scoring information database for storing or keeping information regarding one or more scores, scoring algorithms, etc. One representative scoring information database is exemplified by Table 1 previously discussed above.

The methods of the present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although the present invention has been described with respect to various embodiments thereof, those skilled in the art will note that various substitutions may be made to those embodiments described herein without departing from the spirit and scope of the present invention.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1-41. (canceled)

42. A method comprising:
calculating a respective payoff indicator for each of a first customer and a second customer such that the respective payoff indicator for the first customer is higher than the respective payoff indicator for the second customer, wherein the respective payoff indicator for each customer is calculated by dividing an area under a curve of said each customer's account balance over time by said each customer's present outstanding account balance; and
in response to said payoff indicators,
sending marketing materials to said second customer to solicit said second customer to open another account; and
not sending marketing materials to said first customer.

43. The method of claim 42, wherein said each customer's present outstanding account balance is an account balance in a loan account.

44. The method of claim 43, wherein said another account is a loan account.

45. The method of claim 43, wherein said another account is a credit card account.

46. A system comprising:
a memory;
a communication port; and
a processor connected to said memory and said communication port, said processor being operative to:
calculate a respective payoff indicator for each of a first customer and a second customer such that the respective payoff indicator for the first customer is higher than the respective payoff indicator for the second customer, wherein the respective payoff indicator for each customer is calculated by dividing an area under a curve of said each customer's account balance over time by said each customer's present outstanding account balance; and
respond to said payoff indicators by
sending marketing materials to said second customer to solicit said second customer to open another account; and
not sending marketing materials to said first customer.

47. The system of claim 46, wherein said each customer's present outstanding account balance is an account balance in a loan account.

48. The system of claim 47, wherein said another account is a loan account.

49. The system of claim 47, wherein said another account is a credit card account.

50. A computer program product in a computer readable medium, comprising:
first instructions for calculating a respective payoff indicator for each of a first customer and a second customer such that the respective payoff indicator for the first customer is higher than the respective payoff indicator for the second customer, wherein the respective payoff indicator for each customer is calculated by dividing an area under a curve of said each customer's account balance over time by said each customer's present outstanding account balance; and
second instructions for responding to said payoff indicators by
sending marketing materials to said second customer to solicit said second customer to open another account; and
not sending marketing materials to said first customer.

51. The computer program product of claim 50, wherein said each customer's present outstanding account balance is an account balance in a loan account.

52. The computer program product of claim 51, wherein said another account is a loan account.

53. The computer program product of claim 51, wherein said another account is a credit card account.
